(19) United States
(12) Patent Application Publication
(10) Pub. No.: US 2002/0116253 A1
(43) Pub. Date: Aug. 22, 2002

(54) Systems and methods for making a prediction utilizing admissions-based information

(76) Inventors: Kevin P. Coyne, Atlanta, GA (US); Shawn T. Coyne, Smyrna, GA (US); Peter Flur, Charlotte, NC (US); William Kelly Norton, Atlanta, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/080,014

(22) Filed: Feb. 21, 2002

Related U.S. Application Data
(60) Provisional application No. 60/270,061, filed on Feb. 20, 2001.
(60) Provisional application No. 60/277,180, filed on Mar. 20, 2001.

(51) Int. Cl. G06F 17/60

(52) U.S. Cl. 705/10

(57) ABSTRACT

The invention comprises systems and methods for making a prediction utilizing admissions-based or personal information. The invention receives information associated with the prospective student or person via a network. The invention determines one or more predictive factors based upon selected prospective student information or selected personal information. Finally, the invention determines a likelihood of a decision such as an enrollment decision based upon at least one predictive factor. Information utilized by the invention consists of at least one of the following: static data, biographical data, statistical data, historical data, behavioral data, preferential data, circumstantial data, demographic data, or other data that permits an observation to be made about a person such as the prospective student. The invention develops and updates a predictive algorithm that correlates one or more predictive factors based upon selected prospective student information or personal information.

### FIELD OF THE INVENTION

The present invention generally relates to the field of data processing, and more particularly to systems and methods for making a prediction utilizing admissions-based information.

### BACKGROUND

In the United States, the conventional university or college admissions process can consist of three stages: (1) students send an application to an admissions office; (2) the university or college extends an offer to a prospective student to attend; and (3) the prospective student decides to attend the university or college (i.e., the prospective student “enrolls”). After the second stage, but before the third stage, the admissions office conducts two critical activities: (1) it attempts to contact prospective students to encourage them to enroll, and (2) if the university or college utilizes a multi-round admissions process (e.g. “early action”, or rolling admissions deadlines) it predicts a proportion who will enroll, and adjusts the number of acceptances in the next round. Accordingly, there is a high penalty for accepting too many or too few prospective students in the next round, due to the likelihood of over-filled or under-filled classes in the incoming freshman class.

These two critical activities are currently hampered by the admissions office's inability to dynamically understand the students' frame of mind during the period between stage two and stage three above. Thus, the university or college may spend significant resources contacting students who have already decided to enroll, or not enroll; thus wasting scarce, and expensive resources. Conversely, the university or college may decide against devoting resources to contacting students, because the “wastage” associated with contacting students who have already decided renders the contact activity uneconomic on the average.

Furthermore, if the admissions office must make a decision on the next round of acceptances before the first group must commit, the university or college is forced to decide the number of acceptances based only on historical ratios, etc. Such a decision based upon static information can again lead to too many or too few prospective students in the next round, thus leading to the likelihood of over-filled or under-filled classes in the incoming freshman class.

Thus, a need exists for systems and methods for making a prediction utilizing admissions-based information.

Further, a need exists for systems and methods for generating a prediction as to the prospective student's enrollment into an educational institution.

Furthermore, a need exists for systems and methods for generating an improved prediction based on a combination of static information and recent behavior, including biographical, statistical, historical, behavioral, preferential, circumstantial, demographic data or information provided directly or indirectly by prospective students, one or more educational institutions, or from non-proprietary or proprietary third-party sources.

Yet, another need exists for systems and methods for generating a prediction and matching one or more student interests of particular students to provide guidance as to the type of contact an educational institution should initiate with a prospective student.

In a broader context, a need exists for systems and methods for making a prediction based upon the past behavior of a student or another type of person.

Finally, a need exists for systems and methods for electronically collecting information, thus capturing greater detail, reducing costs, and improving the quality of subsequent predictions of prospective student behavior.

### SUMMARY OF INVENTION

The invention meets the needs above. The invention provides systems and methods for making a prediction utilizing admissions-based information. Further, the invention provides systems and methods for generating a prediction as to the prospective student's enrollment into a educational institution, such that the prediction can be made repeatedly, and adjusted as behavior and circumstances change. Furthermore, the invention provides systems and methods for generating an improved prediction based on a combination of static information and recent behavior, including biographical, statistical, historical, behavioral, preferential, circumstantial, demographic data or information provided directly or indirectly by prospective students, one or more educational institutions, or from non-proprietary or proprietary third-party sources. The invention also provides systems and methods for generating a prediction and matching one or more student interests of particular students to provide guidance as to the type of contact an educational institution should initiate with a prospective student. The invention also provides systems and methods for making a prediction based upon the past behavior of a student or another type of person. Finally, the invention provides systems and methods for electronically collecting information, thus capturing greater detail, reducing costs, and improving the quality of subsequent predictions of prospective student behavior.

Note that the invention can also be utilized in other contexts and business applications, including, but not limited to, commercial ventures, the non-profit sector, direct marketing sales, university market-related alumni, and university market-related athletic booster clubs. For example, the invention could be utilized in commercial ventures such as the training of financial service advisors, insurance agents, or a sales force that may be geographically dispersed and working for a single centralized headquarters.

Generally described, the invention receives information associated with the prospective student via a network. The system determines one or more predictive factors based upon selected prospective student information. Finally, the system determines a likelihood of an enrollment decision of the prospective student based upon at least one predictive factor.

More particularly described, the invention is a system for receiving information associated with a prospective student. The system determines one or more predictive factors based upon selected prospective student information. Finally, the system determines a likelihood of an enrollment decision of a prospective student based upon at least one predictive factor.

In one aspect of the invention, received information consists of at least one of the following: static data, biographical data, statistical data, historical data, behavioral data, preferential data, circumstantial data, demographic data, or other data that permits an observation to be made about the prospective student.

In another aspect of the invention, the invention develops a predictive algorithm that correlates one or more predictive factors based upon selected prospective student information.

In yet another aspect of the invention, the invention utilizes a result based upon at least one predictive factor.

In another aspect of the invention, the invention stores information associated with the prospective student. The invention updates one or more predictive factors based upon selected prospective student information. Finally, the invention determines a likelihood of an enrollment decision based upon at least one updated predictive factor.

In yet another aspect of the invention, the invention determines whether additional information from has been received about a prospective student. Any information is then used to update information associated with the prospective student. Finally, the invention updates one or more predictive factors based upon additional information received about a prospective student.

In yet another aspect of invention, the invention receives additional information associated with a prospective student. The invention sorts relevant information into one or more prediction cells. The invention then determines a predictive factor for each prediction cell. Finally, the invention correlates one or more predictive factors to make a prediction about a student decision based upon the relevant information.

Finally, in yet another aspect of the invention, the invention receives information associated with the person via a network. The invention determines one or more predictive factors based upon selected personal information. Then, the invention determines a likelihood of a decision by the person based upon at least one predictive factor.

### DESCRIPTION OF THE DRAWINGS

FIG. 1 is a functional block diagram illustrating the system architecture of an exemplary embodiment of the invention.

FIG. 2 is a flowchart that illustrates an exemplary method of the invention.

FIG. 3 is a flowchart that illustrates another exemplary method of the invention.

FIG. 4 illustrates an exemplary subroutine of FIG. 3.

FIG. 5 illustrates another exemplary subroutine of FIG. 3.

FIG. 6 illustrates another exemplary subroutine of FIG. 3.

FIG. 7a illustrates a screenshot of a website used in conjunction with the invention.

FIG. 7b illustrates another screenshot of the website used in conjunction with the invention.

FIG. 8 illustrates another screenshot of the website used in conjunction with the invention.

FIG. 9 illustrates another screenshot of the website used in conjunction with the invention.

FIG. 10 illustrates another screenshot of the web site used in conjunction with the invention.

FIG. 11 illustrates another screenshot of the website used in conjunction with the invention.

FIG. 12 illustrates a report generated in conjunction with the invention.

FIG. 13 illustrates another report generated in conjunction with the invention.

FIGS. 14-22 illustrate pages in the report as described in FIG. 13.

### DETAILED DESCRIPTION OF DISCLOSED EMBODIMENTS

The invention provides systems and methods for making a prediction utilizing admissions-based information. The invention provides systems and methods to generate an improved prediction that is more accurate, made in real time, and projects the likelihood of an individual prospective student's enrollment in an educational institution. The aggregates of those predictions can provide summary predictions at various levels of aggregation (e.g., “all rural acceptances”, “all Southern acceptances”, or the entire population). This enables an admissions office for an educational institution to target its contact program to only those students who have not yet decided, and to change the number of acceptances in the next round of a multi-round enrollment process.

The invention comprises one or more routines that execute a statistical and/or a quantitative analysis of data from several sources, including a prospective student's usage of a set of proprietary or non-proprietary Internet web sites specifically designed to enable the prospective student to familiarize himself/herself with the educational institution, other prospective students, etc.

The invention is systems and methods that can be used in combination with any source of data or information that shows a frequency of use of an Internet website where usage of the website is a precursor of a student decision, or otherwise a potential predictor of a student decision. The invention provides systems and methods for improved predictive accuracy of a prospective student's enrollment decision.

Therefore, the invention provides systems and methods for generating a prediction as to a prospective student's enrollment into an educational institution, such that the prediction can be made repeatedly, and adjusted as behavior and circumstances change. Furthermore, the invention provides systems and methods for generating an improved prediction based on a combination of static information and recent behavior, including biographical, statistical, historical, behavioral, preferential, circumstantial, demographic data or information provided directly or indirectly by prospective students, student acceptees, student rejectees, student declinees, student enrollees, one or more educational institutions, or from non-proprietary or proprietary third-party sources. The present invention also provides systems and methods for generating a prediction about a prospective student, and matching one or more interests of the particular student to provide guidance as to the type of contact an educational institution should initiate with the prospective student. Finally, the present invention provides systems and methods for electronically collecting information, thus capturing greater detail, reducing costs, and improving the quality of a subsequent prediction of a prospective student's behavior.

The invention can also be utilized in other contexts and business applications, including, but not limited to, commercial ventures, the non-profit sector, direct marketing sales, university market-related alumni, and university market-related athletic booster clubs. For example, the invention could be utilized in commercial ventures such as the training of financial service advisors, insurance agents, or a sales force that may be geographically dispersed and working for a single centralized headquarters.

“Admissions-based information” as defined by this invention can include, but is not limited to, static data, biographical data, statistical data, historical data, behavioral data, preferential data, circumstantial data, demographic data, or any other data or information that permits an observation to be directly or indirectly made about a student or otherwise provides information about a prospective student. “Personal information” as defined by this invention can include, but is not limited to, static data, biographical data, statistical data, historical data, behavioral data, preferential data, circumstantial data, demographic data, or any other data or information that permits an observation to be directly or indirectly made about a person or otherwise provides information about a person. “Input data” as defined by this invention can include, but is not limited to, information relating to students that have previously made a decision whether to attend a particular educational institution, and information relating to students currently making a decision whether to attend a particular educational institution. “Educational institution” as defined by this invention can include, but is not limited to, an elementary, secondary, or preparatory school; a college, university, or a graduate school; or any other organization that may use admissions-based information to make a decision about interacting with a prospective student or person desiring to enroll or join the organization. “Admissions-based decision” as defined by this invention can include, but is not limited to, a decision related to admissions of a prospective student to an educational institution, such as a selecting a particular type of contact to initiate with a specific student, or selecting particular information content to send or forward to a specific student. “Student” and “prospective student” as defined by this invention can be any person considering enrollment into an educational institution. “Student acceptee” as defined by this invention can include, but not limited to, a student that has been accepted by an educational institution or admissions office, but has yet to make an enrollment decision regarding the educational institution. “Student rejectee” as defined by this invention can include, but is not limited to, as student that has been declined acceptance into the educational institution. “Student enrollee” as defined by this invention can include, but not limited to, a student that has accepted an invitation or offer to enroll in the educational institution, and has actually enrolled in the educational institution. “Student declinee” as defined by this invention can include, but not limited to, a student that has declined an invitation or offer to enroll in the educational institution.

Note that when the invention is applied in other contexts and business applications, the invention processes and applies data related to those specific contexts or business applications. A prediction can then be generated based upon past behavior of a person and/or group of persons. The types of input, persons, institutions, and decisions will also be modified accordingly.

Exemplary Operating Environment

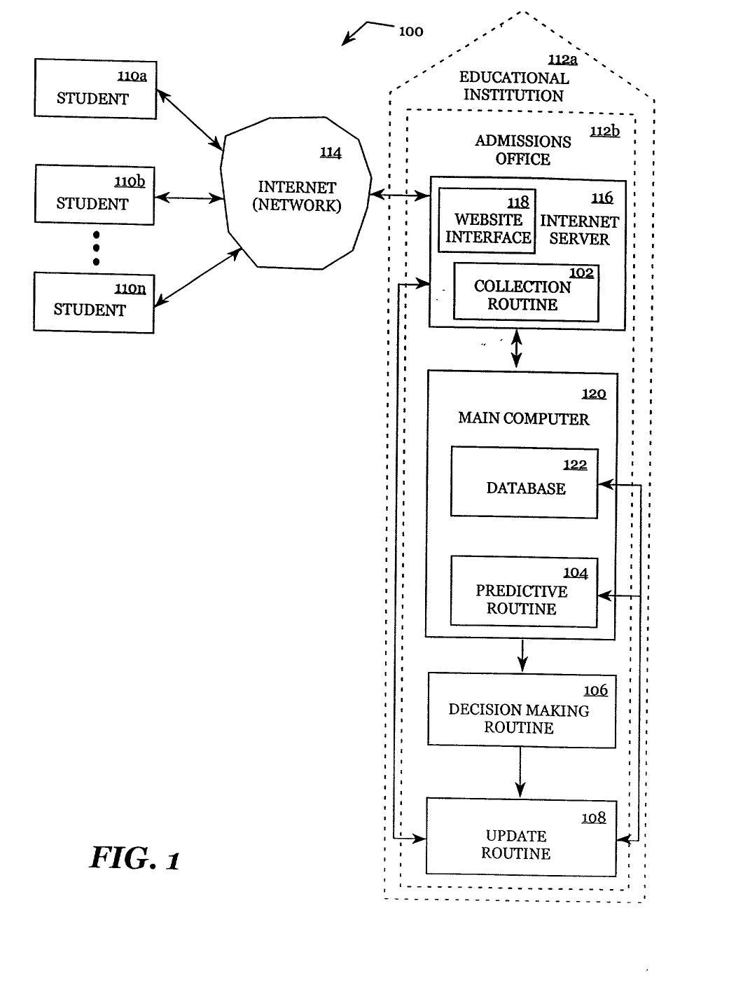

FIG. 1 and the following discussion are intended to provide a brief, general description of the suitable computing environment in which the invention may be implemented. While the invention will be described in the general context of an application program that is executed in conjunction with an operating system by a personal computer, those skilled in the art will recognize that the invention may also be implemented in combination with other program modules and other information-based decision making settings. Generally, program modules include routines, programs, components (such as stacks or caches), data structures, etc., that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communication network. In a distributed computing environment, program modules may be located in both local and remote memory storage devices.

FIG. 1 shows a functional block diagram illustrating a system architecture of an exemplary embodiment of the invention. The invention 100 is shown in a traditional client-server environment. The invention 100 can include a collection routine 102, a predictive routine 104, a decision making routine 106, and an update routine 108. Students 110a-n or clients can communicate with an educational institution 112a such as a university via the Internet 114 or another type of distributed computer network. Typically, an educational institution 112a includes an admissions office 112b that operates or otherwise accesses an Internet server 116. The Internet server 116 can include one or more routines including the collection routine 102.

The Internet server 116 can be in communication with the Internet 114 or another type of distributed network. Another type of distributed network could be a telecommunications network, a cable network, or any other wireless or land-based communication network. The Internet 114 communicates with students 110a-n through clients. Typically, a student 110a-n operates a client such as a processor-driven device, i.e. a personal computer (PC), a laptop computer, a personal digital assistant (PDA), etc., to communicate with the Internet 114 or another type of distributed network.

Students 110a-n or clients may execute a web browser (not shown) to access the collection routine 102 through a website interface 118 or similar type interactive interface between the Internet server 116 and the Internet 114. Typically, a student 110a-n or client can view output of the collection routine 102 and website interface 118 through a display device (not shown).

The collection routine 102 is operable to communicate with students 110a-n or clients via the Internet 114 or a distributed computer network. Furthermore, the collection routine 102 communicates with the educational institution 112a or admissions office 112b in either an electronic or a physical format. Typically, the collection routine 102 is a set of computer-executable instructions stored on the Internet server 116, or another processor-based platform. Through the website interface 118, the collection routine 102 can collect biographical, behavioral, preferential, and statistical data of students 110a-n that communicate with the educational institution 112a or admissions office 112b via the Internet 114. Information in electronic or a physical format can be collected or otherwise received by the collection routine 102 from the educational institution 112a or admissions office 112b. For example, biographical data can include, but is not limited to, hobbies, interests, and contact information. Behavioral data can include, but is not limited to, information collected about a prospective student's behavior during the student's navigation of an Internet website, such as the mouse button clicks or keystrokes performed by a student while browsing a website, including a list of web pages or website accessed and the time spent viewing each web page or website. Preferential data can include, but is not limited to, information collected about a prospective student's preferences during the student's navigation of an Internet website, including information collected from cookies or otherwise input by the student during navigation of web pages or websites. Statistical data can include, but is not limited to, statistical information such as ranges, means, and averages of the biographical or other statistical information collected about all of or a specific portion of students' biographical or preferential information.

The collection routine 102 also disseminates information such as admissions information or other types of information from the educational institution 112a or admissions office 112b to a student 110a-n or client. Admissions information can include, but is not limited to, a final determination by the educational institution or admissions office as to the enrollment status of the prospective student, or information about a particular contact that the educational institution or admissions office has selected for a particular student. Admissions information can be sent to the student 110a-n or client via electronic mail, can be posted to an Internet webpage for selected access by a particular student, or can be posted generally on an Internet website such as the Internet website interface 118. Furthermore, the collection routine 102 can solicit feedback information that includes additional biographical, preferential, or statistical information from the student 110a-n or client.

The collection routine 102 also communicates with a main computer 120 to exchange information for storage and further processing. The main computer 120 includes a database 122 and one or more routines including the predictive routine 104. The main computer can be operated by the educational institution 112a, the admissions office 112b, or by a third-party vendor that administers the database 122 and collects information from one or more educational institutions and admissions offices. Typically, the educational institution 112a, admissions office 112b, or third party vendor can provide information about past students, current students, and prospective students 110a-n including historical data, demographic data, statistical data, behavioral data, circumstantial data. For example, data can be provided by a university such as biographical data about students that accept an admission offer or invitation to enroll in the educational institution 112a. This information can be stored in the database 122, and further accessed by the routines 102, 104, 106, 108 as needed. Specifically, the collection routine 102 may utilize information in the database 122 such as electronic mail addresses to contact students 110a-n via electronic mail.

Historical data can be, but is not limited to, information about past or current students that have enrolled in a particular or another educational institution such as historical admissions data for a specific university or for a group of universities or colleges. Demographic data can be, but is not limited to, information about particular groups, segments, or classifications of a population from which a prospective student can be a member of. Circumstantial data can be, but is not limited to, observational information about a student, or otherwise helpful information about a student that may influence a student's enrollment decision.

The invention includes a predictive routine 104 to create or generate a prediction about a prospective student 110a-n based upon collected information from the collection routine 102 and the database 122. For example, the predictive routine 104 can create or generate a prediction about whether a particular student will enroll in an educational institution 112a. The predictive routine 104 can include a dynamic predictive model or algorithm utilizing statistical and/or quantitative analysis techniques and methods. Statistical and/or quantitative analysis techniques and methods can include, but are not limited to, conventional statistical analysis, quantitative analysis, and a proprietary or non-proprietary set of routines or algorithms. Typically, the predictive routine 104 is a set of computer-executable instructions stored on the main computer 120, Internet server 116, or another similar type of processor-based platform. Information provided by the database 122 and/or the collection routine 102 can be used as inputs into the dynamic predictive model to determine a prediction about a prospective student 110a-n. When the predictive routine 104 is executed by the main computer 120 or another processor-based platform using one or more inputs, a prediction as to a particular student's preferences, enrollment decisions, and other types of admissions-based decisions or student-based preferences can be made.

The predictive routine 104 utilizes biographical data, statistical data, historical data, behavioral data, preferential data, circumstantial data, demographic data, or any other data or information that permits an observation to be directly or indirectly made about a student or otherwise provides information about a prospective student in order to improve the quality of the prediction. The above-described types of information can be provided by the collection routine 102, the update routine 108, the database 122 and/or the main computer 120. The use of these types of information can improve the quality of the prediction as the prediction is no longer reliant solely upon static information such as historical data.

Once a prediction is made, the predictive routine 104 transmits the prediction or analysis to the decision making routine 106. Typically, the decision making routine 106 utilizes the prediction to make a decision such as an admission-based decision about a particular student, e.g. whether to initiate a particular type of contact with a specific prospective student. The decision making routine 106 can include a set of computer-executable instructions such as a computerized admissions program that can make an objective decision based upon the prediction from the predictive routine 104. Alternatively, a decision making routine 106 can be a conventional admissions office decision making body that utilizes the prediction in order to make a decision, such as a particular contact to initiate with a specific prospective student.

Another type of admissions-based decision that can be made by the decision making routine 106 is the regulation of the number of admissions decisions sent out by the educational institution 112a or admissions office 112b. For example, the predictive routine 104 can calculate that the number of student acceptances for a particular round of the enrollment process may exceed a certain predetermined threshold of enrollees. This information is transmitted to the decision making routine 106 and appropriate action can be taken, such as reducing the number of acceptance letters sent to prospective students in the next or subsequent round of a multi-round enrollment process.

The decision making routine 106 is not limited to making admissions-based decisions utilizing the prediction provided by the predictive routine 104. Comparative type analyses can be provided by the predictive routine 104 for input to the decision making routine 106. For example, a prediction or analysis can be matched with indications of a particular student's interests to provide guidance to the admissions office as to the nature of the most effective contact with the prospective student. If a particular prediction or analysis indicates that a prospective student is likely to be interested in the football team, then the decision making routine 106 could decide to have a football player contact the prospective student on behalf of the educational institution.

When a decision is made by the decision making routine 106, the decision can be transmitted to the update routine 108. Typically, the update routine 108 can be a set of computer-executable instructions stored on the admissions main computer 120, Internet server 116, or another processor-based platform. The update routine 108 is operable to receive decision information from the decision making routine 106, and can receive additional information from the collection routine 102 and/or database 122 such as a particular student's decision about whether to enroll in the educational institution 112a. The update routine 108 is further operable to update the database 122, the collection routine 102, and the predictive routine 104 with the information received from the decision making routine 106 or from any of the other routines 102, 104.

The update routine 108 can incorporate information from the decision making routine 106 with other information collected or stored in any of the other routines 102, 104 and then the aggregate information can be utilized by each respective routine to improve the quality of the information and subsequent predictions and decisions drawn from the aggregate information. For example, since the predictive routine 104 utilizes a dynamic predictive model or algorithm utilizing statistical and/or quantitative analysis techniques and methods; decision information transmitted from the decision making routine 106 through the update routine 108; other information collected from the student 110a-n by the collection routine 102 or stored in the database 122; or information otherwise provided by the educational institution 112a or admissions office 112b can be utilized by the model or algorithm to improve or update the predictive routine 104.

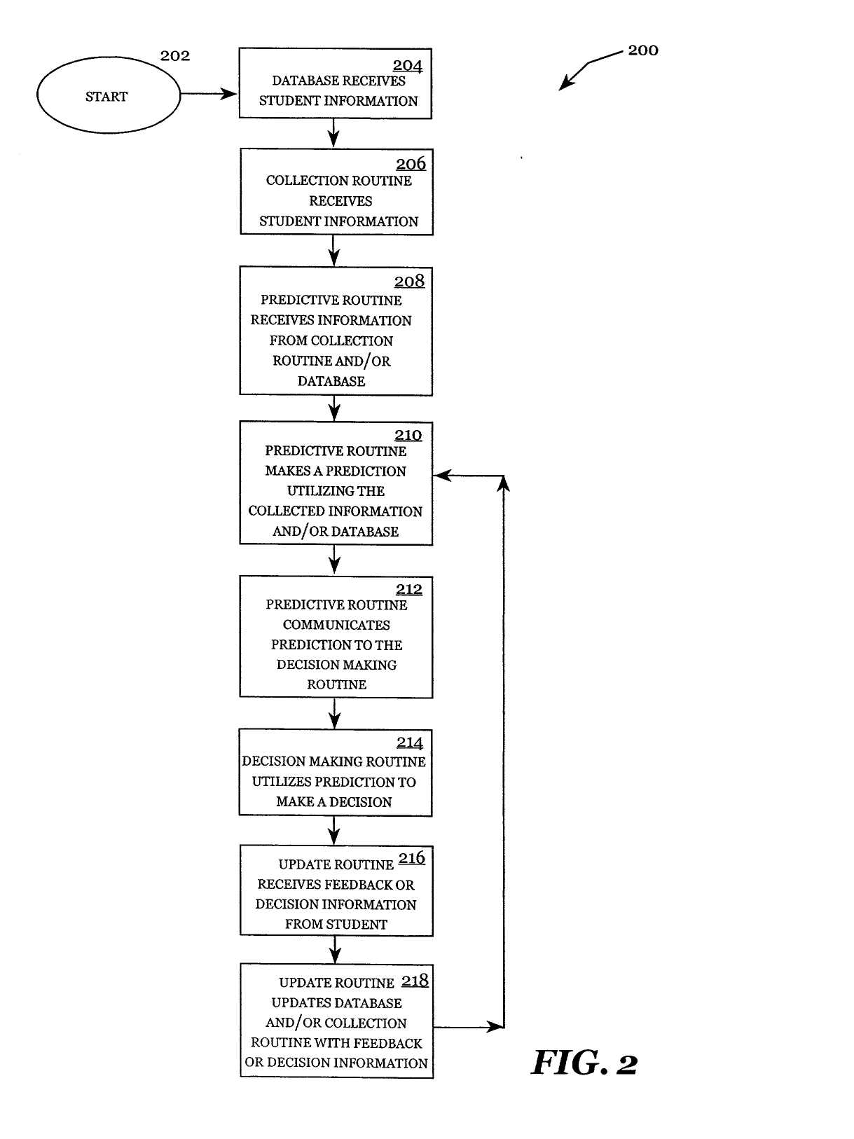

FIG. 2 is a flowchart that illustrates an exemplary method 200 of the invention. The method 200 is intended to operate in conjunction with the exemplary system 100 illustrated in FIG. 1. The method 200 starts at start block 202.

Block 202 is followed by 204, in which the database 122 receives information about students 110a-n. In some cases, information is received from a student 110a-n by the collection routine 102 via the Internet 114 or network. When a student 110a-n interacts through the Internet website interface 118, information is exchanged with the Internet server 116 and the collection routine 102. This information can be stored in the database 122 associated with the main computer 120, or in the main computer 120, until called upon by another routine 104, 106, 108 associated with the system 100. Alternatively, the educational institution 112a or admissions office 112b can provide information to the database 122 such as biographical, historical, and statistical information about students 110a-n to the database 122 associated with the main computer 120. Other sources of information may provide useful information such as historical, demographic, or circumstantial data to the database 122.

204 is followed by 206, in which the collection routine 102 receives information from a student 110a-n. As described above, a student 110a-n can provide information to the collection routine 102 through an Internet website interface 118. This information can be transmitted by the collective routine 104 to the database 122 for storage until called upon by the system 100, as shown in 204. The collection routine 102 may utilize a security or verification procedure that checks the identity of the student through the use of a secure password that has been previously transmitted to the student via electronic or physical format. If the identity of the student is verified, then the student information can be further utilized by the collection routine 102.

The collection routine 102 can preprocess and organize collected information from the students 110a-n. This may involve identifying or sorting specific types of collected information deemed to be relevant for a particular decision about a prospective student.

206 is followed by 208, in which the predictive routine 104 receives information from the collection routine 104 and/or the database 122. Typically, the information transmitted from the collection routine 102 to the predictive routine 104 includes the identified or sorted information deemed to be relevant for a particular decision about a prospective student. As described in FIG. 1, the predictive routine 104 can generate a new or utilize a predefined predictive model of prospective student behavior. The identified or sorted information from the collection routine 102 can be utilized to create predictive factors that may be inputs to a new or predefined predictive model of prospective student behavior.

208 is followed by 210, in which the predictive routine 104 makes a prediction using the collected information and/or other information stored in the database 122. As previously described in FIG. 1, the predictive routine 104 can include a dynamic predictive model or algorithm utilizing statistical and/or quantitative analysis techniques and methods. Statistical and/or quantitative analysis techniques and methods can include, but are not limited to, conventional statistical analysis, quantitative analysis, and a proprietary or non-proprietary set of routines or algorithms. When the information from the collection routine 102 is processed by the predictive routine 104, inputs for a predictive model can be generated, and the predictive model can make, produce or generate an output or predicted decision about prospective student behavior.

210 is followed by 212, in which the predictive routine 104 communicates a prediction to the decision making routine 106. The output or predicted decision about a prospective student is transmitted by the predictive routine 104 to the decision making routine 106 in either an electronic or physical format.

212 is followed by 214, in which the decision making routine 106 utilizes the prediction to make a decision regarding a particular student 110a-n. For example, if the educational institution 112a or admissions office 112b desires to contact a student 110a-n, then the decision making routine 106 can make a decision using one or more of the predictions provided by the predictive routine 104. If the predictive routine 104 predicts that a particular student is inclined to attend the educational institution because of an interest in football, the decision making routine 106 can utilize this prediction to decide that contact with the prospective student can be made by a football player or coach.

Alternatively, the decision making routine 106 can utilize a prediction to decide whether to regulate the number of admissions decisions sent out by the educational institution 112a or admissions office 112b. For example, the predictive routine 104 can calculate that the number of student acceptances for a particular round of the enrollment process may exceed a certain predetermined threshold of enrollees. This information is transmitted to the decision making routine 106 and appropriate action can be taken, such as reducing the number of acceptance letters sent to prospective students in the next or subsequent round of a multi-round enrollment process.

In any case, if the decision making routine 106 makes a decision regarding contact of a prospective student 110a-n, then the prospective student 110an can be contacted based upon the prediction from the predictive routine 104. 214 is followed by 216, in which the update routine 108 receives feedback such as decision information from a prospective student 110a-n. Typically, the student is contacted based upon the prediction from the predictive routine 104. Any feedback from the student such as a decision of whether to accept, reject, or defer a decision by the educational institution 112a or admissions office 112b regarding enrollment for a subsequent or upcoming term, is received either directly by the update routine 108, or by the collection routine 102 which transmits the feedback to the update routine 108. Note that feedback can also be a decision as to an alternative or another educational institution that the student has decided to attend. In any case, the feedback or decision information is transmitted from the student 110a-n to the educational institution 112a or admissions office 112b, either via the collection routine 102 or through an electronic or physical format, which can ultimately be input to the update routine 108, so that the information can be utilized by the update routine 108 to improve future predictions about students.

216 is followed by 218, in which the update routine 108 updates the database 122 and the predictive routine 104 with the feedback or decision information received from the prospective student 110a-n. The update routine 108 processes any feedback from a prospective student 110a-n and updates the database 122 and/or predictive routine 104 as needed.

218 returns to 210, in which the predictive routine 104 can make another prediction utilizing the newly updated information in the database 122 and/or the newly updated predictive routine 104. Utilizing improved predictions about students 110a-n based upon feedback from a prospective student 110a-n improves the quality and timing of decisions by the educational institution 112a and/or admissions office 112b.

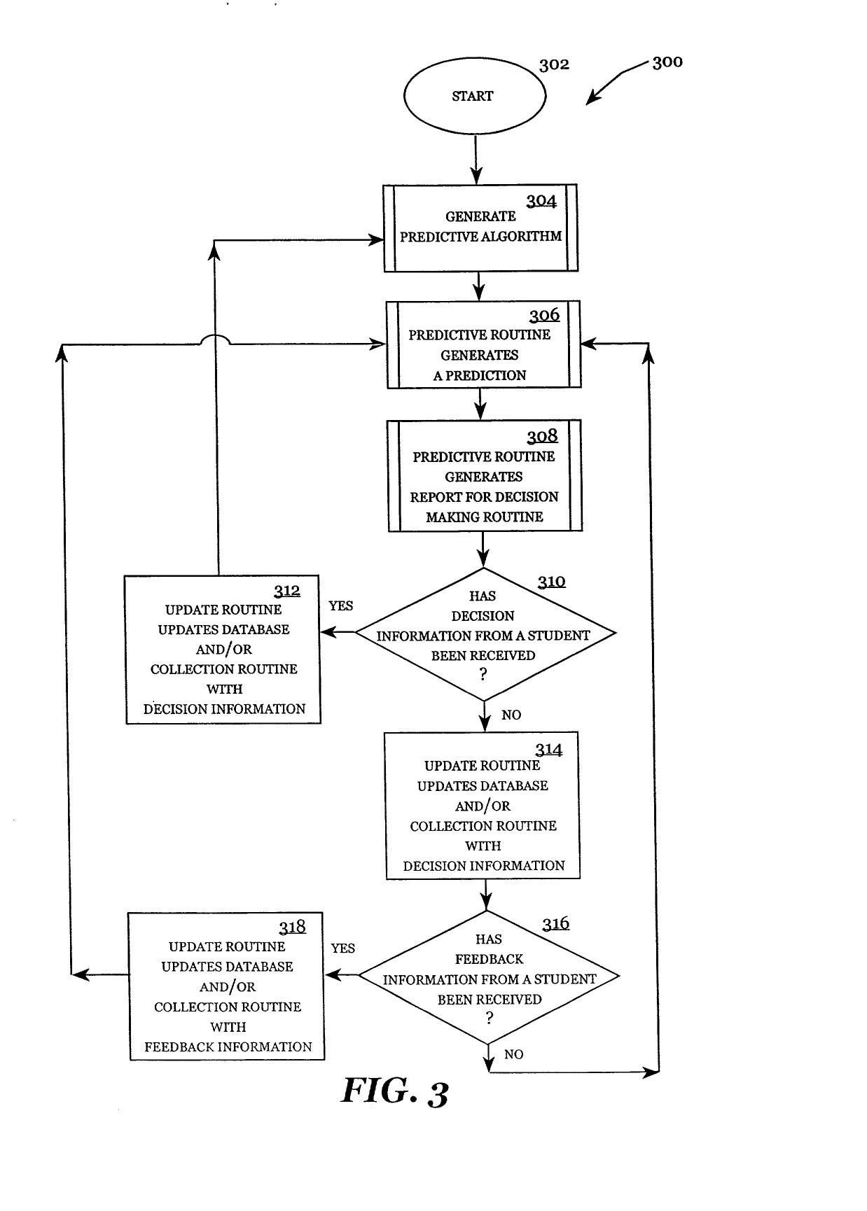

FIG. 3 is a flowchart that illustrates another exemplary method of the invention. The method 300 can be used in conjunction with the system 100 as shown and described in FIG. 1. In FIG. 3, the method 300 begins at 302.

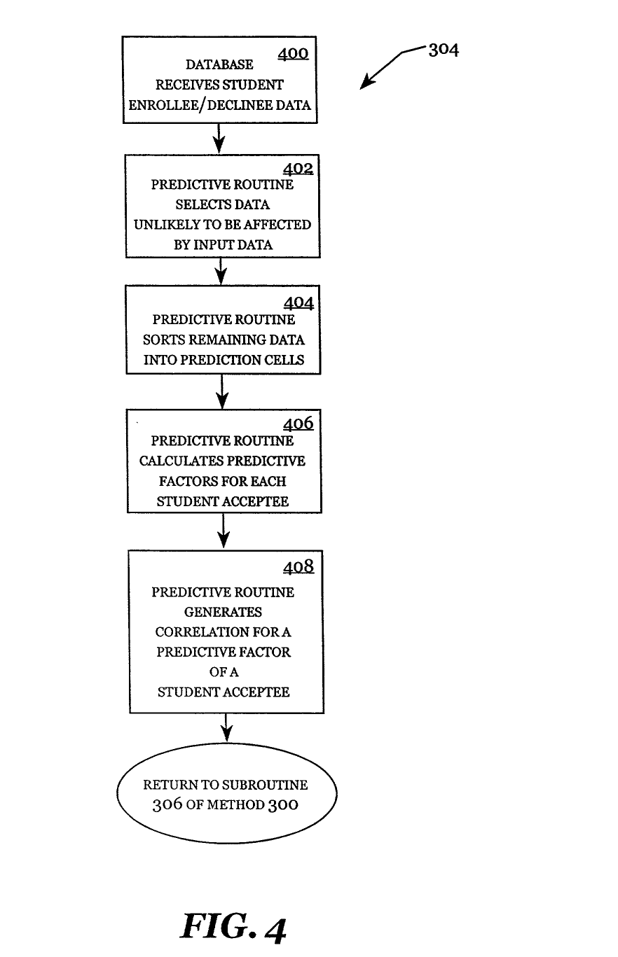

302 is followed by subroutine 304, in which the invention generates a predictive algorithm. Typically, a predictive routine 104 will be stored on a main computer 120, or another processor-based device or platform. As previously described above, the predictive routine 104 includes a predictive algorithm that can be updated by the main computer 120 or by the predictive routine 104 as needed. In general, a predictive algorithm can include a combination of independent variables such as predictive factors and constants such as input data to the predictive algorithm. For example, the predictive routine 104 can utilize information stored in the database 122 to determine or generate one or more predictive factors for a student acceptee. Using the predictive factors, the predictive routine 104 or main computer can then generate a predictive algorithm with one or more of the predictive factors used as independent variables in an equation or formula. A particular student's collected information such as that transmitted by the collection routine 102 may be used as input data to the predictive algorithm. Subroutine 304 is further described in FIG. 4 below.

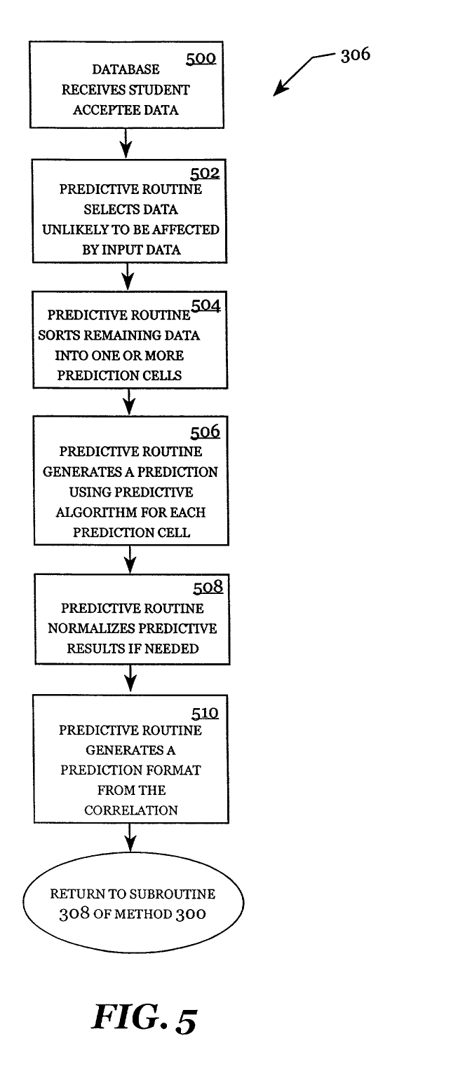

Subroutine 304 is followed by subroutine 306, in which the predictive routine 104 generates a prediction. Typically, feedback or decision information from the update routine 108, information from the database 122 and/or collected information from the collection routine 102 can be utilized by the predictive routine 104 to generate a prediction. Generally, predictions are made about students that have been accepted to the educational institution 112a but have not yet made a final decision as to whether to attend or enroll, i.e. student acceptees. For example, a particular student's collected information from the collection routine 102 may be used as input data to the predictive algorithm, from which a prediction can be generated based upon a correlation of each predictive factor with a student acceptee's potential decision. Subroutine 306 is further described in FIG. 5 below.

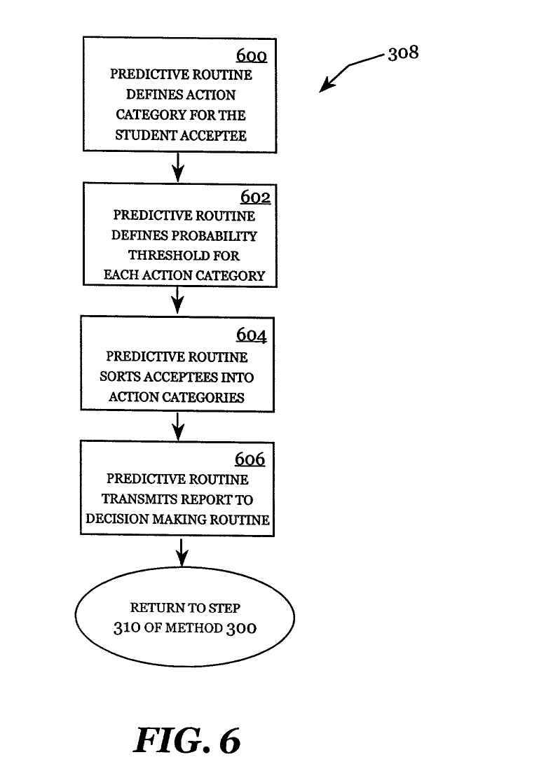

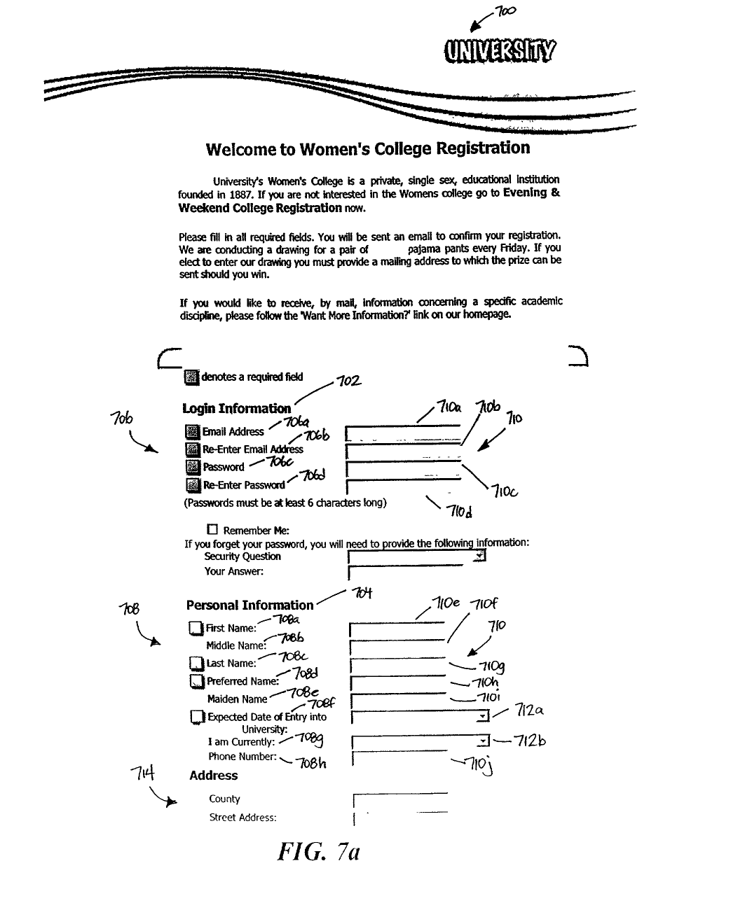

In subroutine 308, the predictive routine 104 converts one or more of the generated predictions to useful reports for the decision making routine 106 to handle or otherwise utilize. A useful report can include a form in an electronic or physical format that includes one or more predictions about a particular student's potential decision. Subroutine 308 is further described in FIG. 6 below.

Subroutine 308 is followed by decision block 310, in which the update routine 108 determines whether a student decision has been received. In some instances, after the decision making routine 106 makes a decision utilizing the prediction or creates a report including a prediction from the predictive routine 104, a student acceptee can be notified of the decision or otherwise contacted in a manner utilizing the prediction. For example, based upon a prediction or report, the educational institution 112a or admissions office 112b can make a decision regarding contacting a student acceptee, or otherwise takes action regarding a prediction or report regarding a prospective student. After the student acceptee is notified of the decision or otherwise contacted by the educational institution 112a or admissions office 112b utilizing the prediction, the student acceptee can make a decision regarding enrollment into the educational institution 112a and transmit decision information back to the educational institution 112a or admissions office 112b. The student acceptee decision information can be transmitted through the collection routine 102 and forwarded to the update routine 108.

The update routine 108 can also be programmed to determine when student decision information has been received, either directly from the student acceptee through the collection routine 102 via an Internet website, or from the educational institution 112a or admissions office 112b via a written, oral, electronic or other communication from a student. If the collection routine 102 receives the decision information, the collection routine 102 can transmit the decision information directly to the update routine 108. If the admissions office 112b or educational institution 112a receives the decision information, then the admissions office 112b or educational institution 112a can transmit the decision information to the update routine 108 via the main computer 120 or decision making routine 106.

If the update routine 108 determines that a student acceptee has made a decision, then the “YES” branch is followed to 312. In 312, the update routine 108 updates the database 122 with information that a particular student has previously made an enrollment decision. Furthermore, the update routine 108 can update the collection routine 102 with information that a particular student has made an enrollment decision. For example, a student acceptee can decide not to attend the educational institution 112a, in which case the update routine updates the database 122 as to the status of student's decision and to the student's classification. That is, the student has made a decision, and the status of that student becomes that of a “student declinee”. This type of information can affect the input data for the predictive algorithm, such as the inputs of students who have previously made a decision. In either case, after the update routine 108 has made changes based upon the received decision information from the student, the method 300 returns to subroutine 304 in which the main computer 120 develops an improved predictive algorithm utilizing the newly received decision information.

Returning to decision block 310, if the student acceptee has not made a decision, then the “NO” branch is followed to 314. In 314, the update routine 108 updates the database 122 with information that a particular student has not made an enrollment decision. Furthermore, the update routine 108 can update the collection routine 102 with information that a particular student has not made an enrollment decision. For example, the fact that a student acceptee has not yet decided to attend the educational institution 112a, can be stored by the update routine 108 in the database 122. This information may affect the input data to the predictive algorithm, such as the inputs of students currently making a choice.

314 is followed by decision block 316, the update routine 108 determines whether feedback information from the student acceptee has been received. In some instances, if the student acceptee does not communicate a decision to the educational institution 112a or to the admissions office 112b, then the student acceptee may communicate feedback information that is useful to making a prediction about the student's behavior. Typically, the student acceptee will communicate this feedback information to the educational institution 112a or admissions office 112b through the Internet website interface 118, or via a written, oral, or electronic format. Such feedback information can be collected by the collection routine 102, or stored in the database 122 or main computer 120. In any case, the feedback information can be transmitted to or otherwise received by the update routine 108. For example, a student acceptee that has not yet decided to attend the educational institution 112a may communicate feedback information that he or she is interested in particular aspects of the educational institution 112a such as financial aid. Such feedback information may be in the form of visits to the financial aid section of the Internet website interface 118. The collection routine 102 can collect this feedback information and communicate such information to the update routine 108.

If the update routine 108 determines that feedback information has been received, then the “YES” branch is followed to 318. In 318, the update routine 108 updates the database 122 with information that a particular student has transmitted feedback information to the educational institution 112a or to the admissions office 112b. Furthermore, the update routine 108 can update the collection routine 102 with information that a particular student has transmitted feedback information. For example, if a student does indicate an interest in the financial aid sections of the Internet website interface 118, then the update routine 108 can transmit such feedback information to the database 122. In either case, after the update routine 108 has made changes based upon the received feedback information from the student, the method 300 returns to subroutine 306 in which the predictive routine 104 generates a new prediction utilizing the newly received feedback information and the prediction algorithm.

Returning to decision block 316, if the student acceptee has not transmitted any feedback information, then the “NO” branch is followed back to subroutine 306, in which the predictive routine 104 or main computer 120 generates a prediction using the predictive algorithm, further accounting for the lack of or this type of feedback information from the student acceptee. Sometimes, if the student acceptee does not communicate feedback information to the educational institution 112a or to the admissions office 112b, then the lack of or this type of information may still be useful to making a prediction about the student's behavior. For example, a student acceptee that has not yet decided to attend the educational institution 112a may not communicate with the educational institution 112a for an extended period of time. This type of information such as the fact that the student acceptee has delayed making a decision or the amount of the delay in time may be useful in generating a new prediction about the student's behavior using the predictive algorithm created in subroutine 204.

FIG. 4 illustrates an exemplary subroutine 304 of FIG. 3. Subroutine 304 begins at 400, in which the database 122 receives data about student enrollees and/or student declinees. That is, data associated with students that have previously made a choice or decision about attending the educational institution 112a is transmitted to the database 122. These students may be from the current class of students or any number of previous classes of students for a particular educational institution. This data can be stored in the database 122 or another type of memory storage device for later access by the predictive routine 104 or the system 100. The data can also include static data, behavioral and preferential data, decision data, and other data or information from other sources such as the update routine 108. The static data can include, but is not limited to, biographical information including gender, race, location, and intended major in course studies. Behavioral and preferential data can include, but is not limited to, the number of website and/or webpage visits, the number of website and/or webpage features viewed, used, or accessed, and the access connection speed including the communication access speed, the bandwidth used, and time spent at the website, webpage, or feature. Decision data can include, but is not limited to, information relating to the student's eventual enrollment choice in a particular educational institution, i.e. whether the student chose to attend this educational institution, or information that another educational institution was selected instead.

400 is followed by 402, in which the predictive routine 104 selects student data unlikely to be affected by input data. That is, the predictive routine 104 selects or filters student data to be removed from the database 122, or otherwise flags particular student data in the database 122, when a particular student's decision is unlikely to be affected by such data when input to the predictive routine 104. Such student data to be removed, filtered, or flagged includes data associated with students that have already selected an educational institution to attend, and those students whose choice relies upon factors entirely outside of measure or calculation by the system 100, i.e. scholarship, athletics, or children of faculty, or students who cannot access the Internet for certain reasons, including lack of Internet access, physical or mental disability, and language or linguistic barriers. Other similar types of data can be removed, filtered, or flagged depending upon the relevancy of the information to a particular student decision being predicted by the predictive algorithm.

402 is followed by 404, in which the predictive routine 104 sorts the remaining or unflagged student information in the database 122 into one or more “prediction cells”. Typically, the remaining or unflagged student information includes information about student acceptees. This information is considered particularly relevant to a particular student decision being predicted by the predictive algorithm. Each relevant portion of information is sorted into an individual “prediction cell” for further processing by the predictive routine 104. A prediction cell is an independent observation of student group behavior that can function as an independent variable, and can affect the predictive value of identical status or of a predictive variable. For example, a prediction cell can be based upon, but not limited to, the volume and/or frequency of Internet access, and observations such as the following: some groups of students use the Internet for general purposes more than other groups; males may use the Internet more often than females; students living in urban and suburban areas may use the Internet more often than those living in rural areas; and those students accessing the Internet using high speed access connections may use the Internet with a greater frequency than those with low speed access connections. By using any of these or other observations about a student group or a subset of the entire student prospective student population, one or more prediction cells can be created by the predictive routine 104.

404 is followed by 406, in which the predictive routine 104 calculates a “prediction factor” for a student acceptee. The information associated with each prediction cell from 402 is accumulated by the predictive routine 104 and utilized to produce a prediction factor. Depending upon the number of prediction cells, one or more prediction factors can be calculated for each student acceptee. For example, information such as “the number of visits an acceptee has made to a particular website” and “the duration of the enrollment period” can be accumulated, and the results can be combined in a mathematical equation to determine the number of website visits per week of the duration of the enrollment period. The resultant numerical value can equal a prediction factor that may be indicative or predictive of the likelihood of the student acceptee to enroll in the educational institution.

Prediction factors can include, but are not limited to, individual or combinations of static factors and/or website usage factors. Static factors can include, but are not limited to: factors that suggest whether an academically superior school is likely to have also accepted a prospective student, e.g. Scholastic Aptitude Test (SAT)® or other achievement-type test scores; grade point average (GPA), or the existence of a standardized common applications form; factors that generally lead to lower enrollment rates, e.g. competitive cost of a particular educational institution compared to others; the distance of a particular educational institution from the prospective student's home compared to other identified educational institutions; and indicators of a prospective student's level of interest, e.g. level and quality of contact that the prospective student has had with the educational institution or admissions office; and whether the prospective student has made one or more personal visits to the educational institution.

Website usage factors include, but are not limited to: aggregate measures of a prospective student's usage of or access to a particular Internet website or web page, e.g. the average number of site or page visits per week; the average number of hits per visit, and the clock time spent visiting the website or each web page; the usage of particular features, e.g. downloading particular documents such as the educational institution's screen saver, visits to the financial features such as financial aid information or links; the number of other acceptees whom the particular acceptee has made connection or communication with through a particular website; the breadth of usage measures, e.g. the total number of different or distinct features used; and the total number of associated message boards or chat rooms the particular acceptee has used; the trends in a particular acceptee's usage, e.g. weekly trends in the total number of visits per week and weekly trends in the total time spent on the website per week; and peer-to-peer interactions, e.g. electronic mail or instant messenger messages to other students, or message board traffic.

Note that other static factors and website usage factors exist that can be utilized by the predictive routine 104 to determine a prediction factor that may be indicative or predictive of the likelihood of the student acceptee to enroll in the educational institution.

406 is followed by 408, in which the predictive routine 104 generates a correlation using a prediction factor for a student acceptee. That is, for each prediction cell, the predictive routine 104 utilizes a prediction factor and then generates a correlation between one or more prediction factors and a student acceptee's potential decision. Various statistical methods can be utilized by the predictive routine 104, including but not limited to, linear regression, non-linear regression, multi-variable regression, cluster analysis, neural network analysis, etc. An analysis of the data for each prediction cell is made using any one or a combination of statistical methods until a correlation is made between one or more of the prediction factors and a student's potential decision. Once a correlation is made, the correlation can be utilized as a predictive algorithm by the predictive routine 104 to generate a prediction about a student's behavior.

After 408, the subroutine 304 returns to subroutine 306 of method 300.

FIG. 5 illustrates another exemplary subroutine 306 of FIG. 3. Subroutine 306 starts at 500, in which the database 122 receives data about student acceptees. That is, students that have been extended an invitation or offer to attend the educational institution, but have yet to make a choice or decision about attending the educational institution 112a. This data can be stored in the database 122 for later access by the predictive routine 104 or system 100. The data can also include static data, behavioral and preferential data, decision data, and other data or information from other sources such as the update routine 108. The static data can include, but is not limited to, biographical information including gender, race, location, and intended major in course studies. Behavioral and preferential data can include, but is not limited to, the number of website and/or webpage visits, the number of website and/or webpage features viewed, used, or accessed, and the access connection speed including the communication access speed, the bandwidth used, and time spent at the website, webpage, or feature. Decision data can include, but is not limited to, information relating to the other student acceptees' eventual enrollment choices in a particular educational institution, i.e. whether the student chose to attend this educational institution, or information that another educational institution was selected instead.

500 is followed by 502, in which the predictive routine 104 selects student data unlikely to be affected by input data. That is, the predictive routine 104 selects or filters student data to be removed from the database 122, or otherwise flags the student data in the database 122, when a particular student's decision is unlikely to be affected by input data to the predictive routine 104. Such student data to be removed, filtered, or flagged includes data associated with students that have already selected an educational institution to attend, and those students whose choice relies upon factors entirely outside of measure or calculation by the system 100, i.e. scholarship, athletics, or children of faculty, or students who cannot access the Internet for certain reasons, including lack of Internet access, physical or mental disability, and language or linguistic barriers.

502 is followed by 504, in which the predictive routine 104 sorts the remaining student information in the database 122 into one or more “prediction cells”. Typically, the remaining or unflagged student information includes information about student acceptees. This information is considered particularly relevant to a particular student decision being predicted by the predictive algorithm. Each relevant portion of information is sorted into an individual “prediction cell” for further processing by the predictive routine 104. A prediction cell is an independent observation of student group behavior that can function as an independent variable that can affect the predictive value of identical status or of a predictive variable. For example, a prediction cell can be based upon the volume and frequency of Internet access such as, but not limited to, the following observations: some groups of students use the Internet for general purposes more than other groups; males may use the Internet more often than females; students living in urban and suburban areas may use the Internet more often than those living in rural areas; and those students accessing the Internet using high speed access connections may use the Internet with a greater frequency than those with low speed access connections. By using any of these or other observations about a student group or a subset of the entire student prospective student population, one or more prediction cells can be created by the predictive routine 104.

504 is followed by 506, in which the predictive routine 104 generates an initial prediction of each student acceptee's decision using a predictive algorithm for each prediction cell. That is, the predictive routine 104 utilizes input data including information associated with each student acceptee, and generates a prediction about a student acceptee using the predictive algorithm generated in 206-208. Typically, data from the database 122, collected information from the collection routine 102 and/or the update routine 108 can be used as input data to the predictive algorithm. In this manner, the predictive routine 104 can generate an initial prediction for a particular student acceptee based upon the predictive algorithm, specific data inputs, and information associated with each student acceptee.

506 is followed by 508, in which the predictive algorithm normalizes the initial prediction to match educational institution-specific actual results if needed. For example, in some instances when a prediction cell contains little or no student information to make a meaningful prediction based upon a single educational institution's data alone, then the predictive routine 104 may generate an initial prediction using other data from multiple educational institutions. However, since the total portion of enrollments varies greatly among educational institutions, the likelihood can be calibrated to a particular educational institution's portion to avoid distortion of the prediction.

508 is followed by 510, in which the predictive routine 104 converts the correlation into a prediction format. That is, the predictive routine 104 converts the statistical relationship or correlation in each prediction cell into a mathematical equation where the prediction factors or independent variables selected such as in 406 and an objective function take on a prediction format. For example, a prediction format can be “What is the predicted likelihood (constrained between 10% and 90% probability) of the student's decision being ‘yes’?” or “What is the ranking of this particular student's likelihood of deciding ‘yes’ versus that of all the other students in the same particular predictive cell?” At least one prediction format is created for each prediction cell.

After 510, the subroutine 306 returns to subroutine 308 of method 300.

FIG. 6 illustrates another exemplary subroutine 308 of FIG. 3. Subroutine 308 begins at 600, in which the predictive routine 104 defines an “action category” of an acceptee that can be useful for planning by the educational institution 112a or admissions office 112b. An “action category” is a predefined group that is identified by the educational institution's ability to act upon or influence the particular group in a certain manner. For example, if the educational institution is prepared to launch a telephone contact campaign and has access to volunteer callers with many corresponding interests, the educational institution may want to define one or more action categories that correspond to an interest selected by the acceptee, e.g. “swimming”, “fraternities”, or “Southern students”. In this manner, a particular volunteer caller sharing a particular interest such as an action category can contact an acceptee with the common, shared interest.

Alternatively, if the educational institution wants to send a gift such as a school poster to prospective students or acceptees with the highest SAT scores among the group that still have not made an enrollment decision, a particular action category to identify these particular acceptees can also be defined.

600 is followed by 602, in which the predictive routine 104 identifies a probability threshold for each action category to warrant action. For example, a probability threshold can be “all students in a particular action category with probability scores between 30% and 60%.” Alternatively, probability thresholds can also be established for ranges of students within a ranking such as “the lowest 50 students in a particular category.”

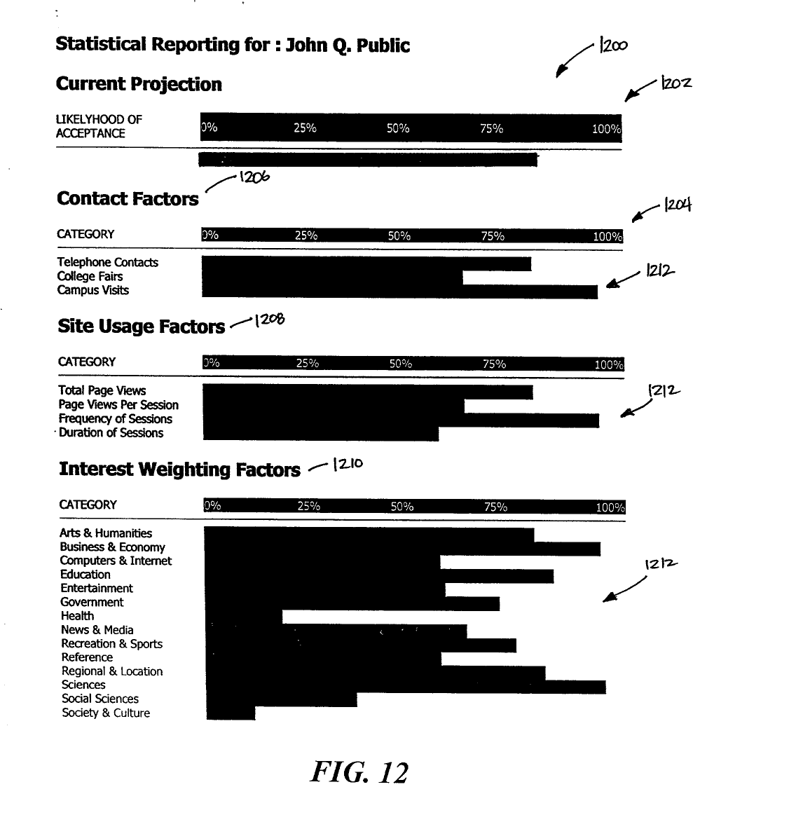

602 is followed by 604, in which the predictive routine 104 organizes the student acceptees into one or more predefined action categories with associated probability thresholds. The organization of student acceptees into action categories permits an organized report including one or more predictions about a student acceptee to be generated and transmitted. An example of a report is illustrated in FIG. 12.

604 is followed by 606, in which the predictive routine 104 transmits the report to the decision making routine 106.

After 606, the subroutine returns to 310 of method 300.

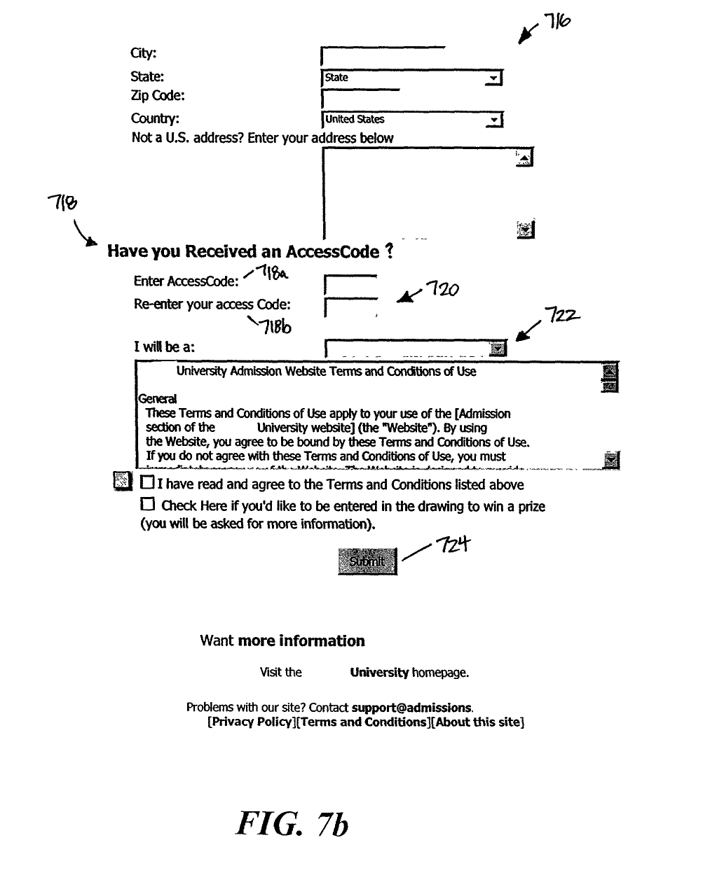

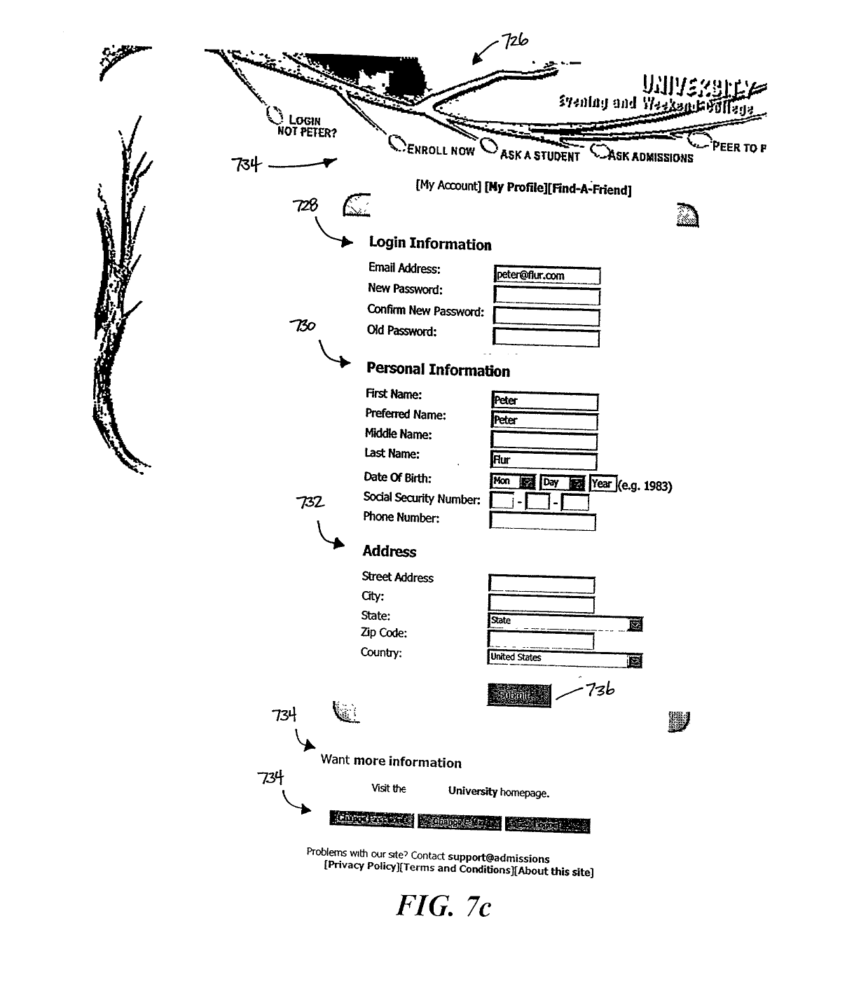

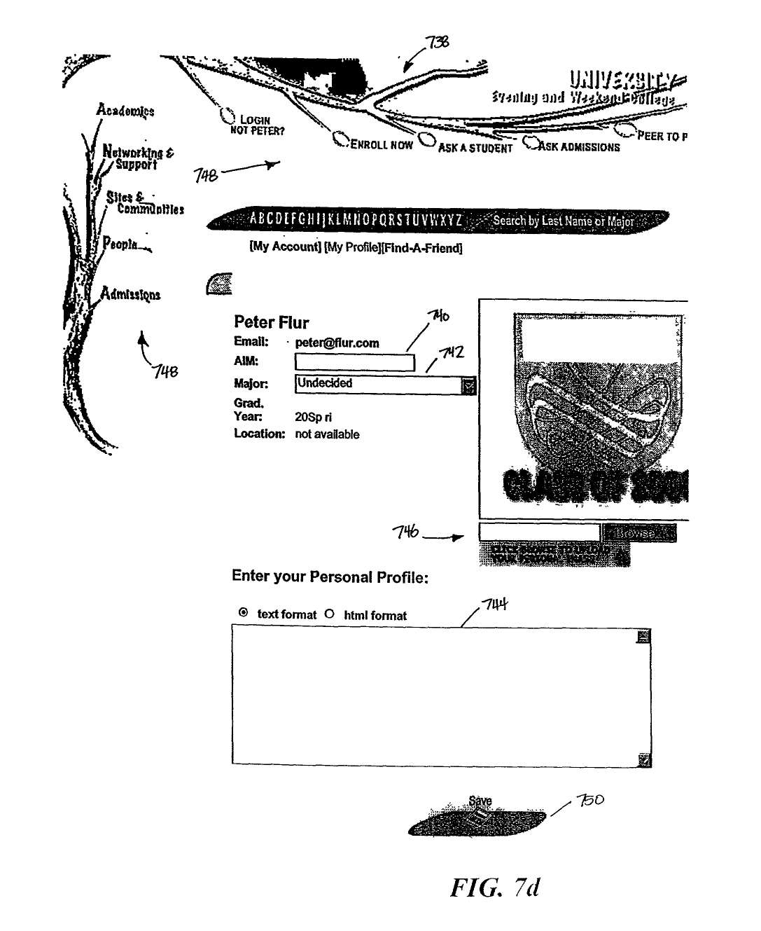

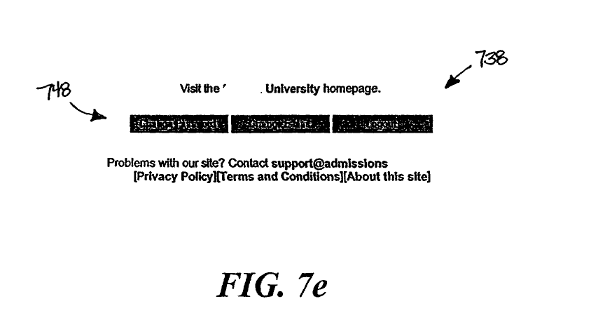

FIGS. 7a-7e illustrate screenshots of a website used in conjunction with the invention. As previously described in FIG. 1, students 110a-n or clients may execute a web browser (not shown) to access the collection routine 102 through a website interface 118 or similar type interactive interface between the Internet server 116 and the Internet 114. An example of a website interface 700 is shown in FIGS. 7a-7e. The particular website interface 700 in FIGS. 7a-7b relates to a registration procedure or method executed by the invention to gather personal information directly from a prospective student. The personal information gathered by the website interface 700 shown can be validated and augmented by data provided by an educational institution 112a or other source. The website interface 700 in this example includes headings such as “Login Information” 702, and “personal Information” 704. Each heading 702, 704 has one or more associated subheadings 706-708 that query or otherwise prompt a prospective student to enter information into an associated field 710. For example, the “Login Information” heading 702 can have subheadings of “email address” 706a, “re-enter Email Address” 706b, “Password” 706c, and “Re-enter password” 706d. A respective text field 710a-d immediately adjacent to each subheading 706a-d provides a prospective student with an interface to enter information responsive to each subheading 706a-d by way of an input device such as a keyboard or mouse. In this example, a collection routine 102 may utilize the collected information from a prospective student with a security or verification procedure that checks the identity of the student through the use of a secure password that has been previously transmitted to the student via electronic or physical format. If the identity of the student is verified, then the student information can be further utilized by the collection routine 102. Other headings, subheadings, and fields can exist.

Additional information such as biographical data can be collected by the website interface 700. As shown in FIG. 7a, beneath the heading “Personal information” 704, subheadings such as “First Name” 708a, “Middle Name” 708b, “Last name” 708c, “Preferred Name” 708d, “Maiden Name” 708e, “Expected Date of Entry Into University” 708f, “I am Currently” 708g, and “Phone Number” 708h query or otherwise prompt a prospective student for additional information such as biographical data. A respective text field 710e-j or pull down box 712a-b immediately adjacent to each subheading 706-712 provides a prospective student with an interface to enter information responsive to each subheading 708a-h by way of an input device such as a keyboard or mouse. As shown, additional information can be prompted and collected from a prospective student such as address-type data 714.

FIG. 7b illustrates another screenshot of the website used in conjunction with the invention. This particular website interface 716 also relates to a registration procedure or method executed by the invention to gather personal information directly from a prospective student. The personal information gathered by the website interface 716 shown can also be validated and augmented by data provided by an educational institution 112a or other source. The website interface 716 in this example includes headings such as “Have You Received an Access Code?” 718. Each heading 718 has one or more associated subheadings 718a-b that query or otherwise prompt a prospective student to enter information into an associated field 720. For example, the “Have You Received an Access Code?” heading 718 can have subheadings of “Enter Access Code” 718a, “Re-enter your access Code” 718b. A respective text field 720 or text-pull down box 722 immediately adjacent to each subheading 718a-b provides a prospective student with an interface to enter information responsive to each subheading 718a-b by way of an input device such as a keyboard or mouse. In this example, a collection routine 102 can utilize the collected information from a prospective student with a security or verification procedure that checks the identity of the student through the use of a secure password that has been previously transmitted to the student via electronic or physical format. If the identity of the student is verified, then the student information can be further utilized by the collection routine 102. Other headings, subheadings, and fields can exist.

Additional personal information such as data that permits an observation to be made about the prospective student can be collected by the website interface 716. When a prospective student has completed data entry for the website interface 716 and is ready to move to a subsequent webpage, he/she depresses the “Submit” button 724 by way of an input device or mouse.

The particular website interface 726 in FIG. 7c also relates to a registration procedure or method executed by the invention to gather personal information directly from a prospective student. In this webpage, a prospective student or user can input, change or otherwise update personal information in an account, including “Login Information” 728 such as email address and password; “Personal Information” 730 such as first name, preferred name, middle name, last name, date of birth, and social security number; and “Address”-type information 732 such as street address, city, state, zip code, and country. A prospective student may select from a range of different user options 734 by way of an input device or mouse. These options can include, but are not limited to, login under a different name, enrollment, submit a question to another student, submit a question to an admissions office, peer-to-peer communications, my account options, find-a-friend, or visit the university homepage.

When a prospective student has completed data entry for the website interface 726 and is ready to move to a subsequent webpage, he/she depresses the “Submit” button 736 by way of an input device or mouse.

The particular website interface 738 in FIGS. 7d-7e also relates to a registration procedure or method executed by the invention to gather personal information directly from a prospective student. In this webpage, a prospective student or user can input, change or otherwise update personal information in a unique student profile, such as “AIM” 740, “Major” 742, and “Personal Profile” 744. An option 746 to upload a personal image file to the website is also provided.

A prospective student may select from a range of different user options 748 by way of an input device or mouse. These options can include, but are not limited to, academics, networking & support, sites & communities, people, admissions, as well as, login under a different name, enrollment, submit a question to another student, submit a question to an admissions office, peer-to-peer communications, my account options, find-a-friend, or visit the university homepage.

When a prospective student has completed data entry for the website interface 738 and is ready to move to a subsequent webpage, he/she depresses the “Save” button 750 by way of an input device or mouse.

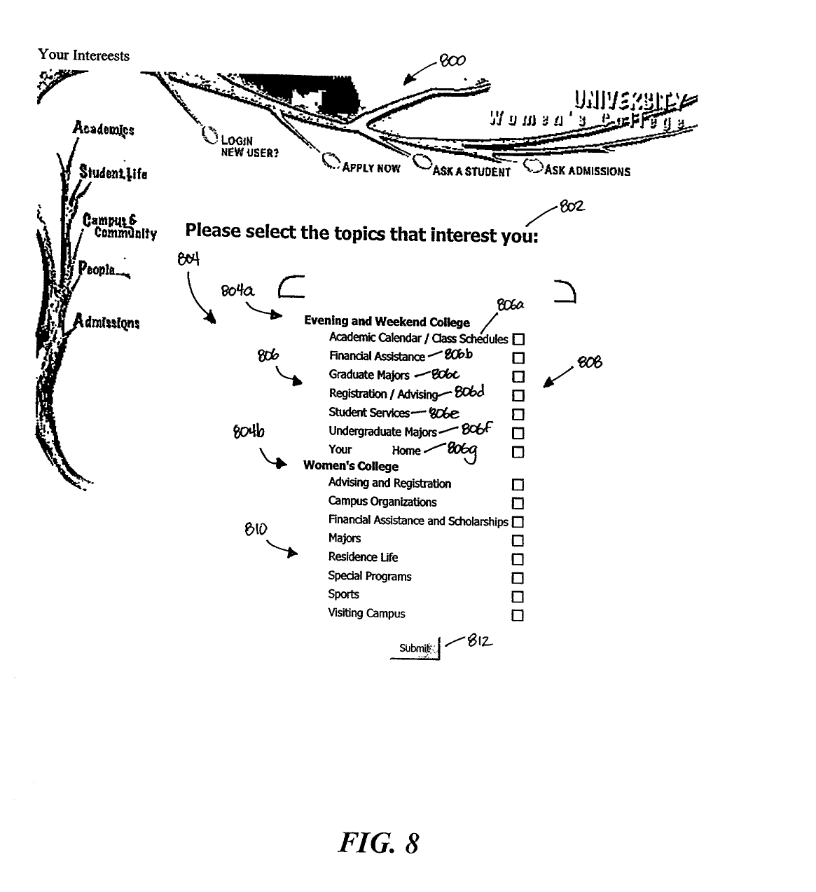

FIG. 8 illustrates another screenshot of a website used in conjunction with the invention. This particular website interface 800 relates to a survey procedure or method executed by the invention to gather personal information directly from a prospective student. Typically, the type of personal information collected in a survey procedure or method may not be determined from another source. The personal information gathered by the website interface 800 shown can then be stored and augmented by data provided by an educational institution 112a or other source. The website interface 800 in this example includes headings 802 such as “Please Select the Topics that Interest You”. Each heading 802 has one or more associated general topic headings 804 with more specific subheadings 806 that query or otherwise prompt a prospective student to enter information into an associated field or check box 808. For example, the “Please Select the Topics that Interest You” heading 802 can have general subheadings of “Evening and Weekend College” 804a, “Women's College” 804b. Examples of more specific subheadings for the “Evening and Weekend College” 804 subheading are “Academic Calendar/Class Schedules” 806a, “Financial Assistance” 806b, “Graduate Majors” 806c, “Registration/Advising” 806d, “Student Services” 806e, “Undergraduate Majors” 806f, and “Your Home” 806g. A respective check box 808 immediately adjacent to each subheading 806a-g provides a prospective student with an interface to enter information responsive to each specific subheading 808 by way of an input device such as a keyboard or mouse. In this example, a collection routine 102 may utilize the collected information from a prospective student with a procedure that augments the information with data provided or otherwise collected by an educational institution 112a or another source, such as behavioral data of current and prior students at a particular educational institution. The type of information collected in the website interface 800 can then be used to predict the behavior of a prospective student based upon the behavioral data and observations of current and prior students. For example, based upon the demographic data and interests of a prospective student, a prediction may be made of that prospective student when such data and information is compared to the demographic data and interests of current and prior students of a particular educational institution. The prediction can then be further utilized by the collection routine 102 or invention. Other headings, subheadings, and check boxes can exist.

Additional personal or survey information 810 such as data that permits an observation to be made about the prospective student can be collected by the website interface 800. Other personal and survey information questions can be displayed, and associated input can be collected and stored by the website interface 800. When a prospective student has completed data entry for the website interface 800 and is ready to move to a subsequent webpage, he/she depresses the “Submit” button 812 by way of an input device or mouse.

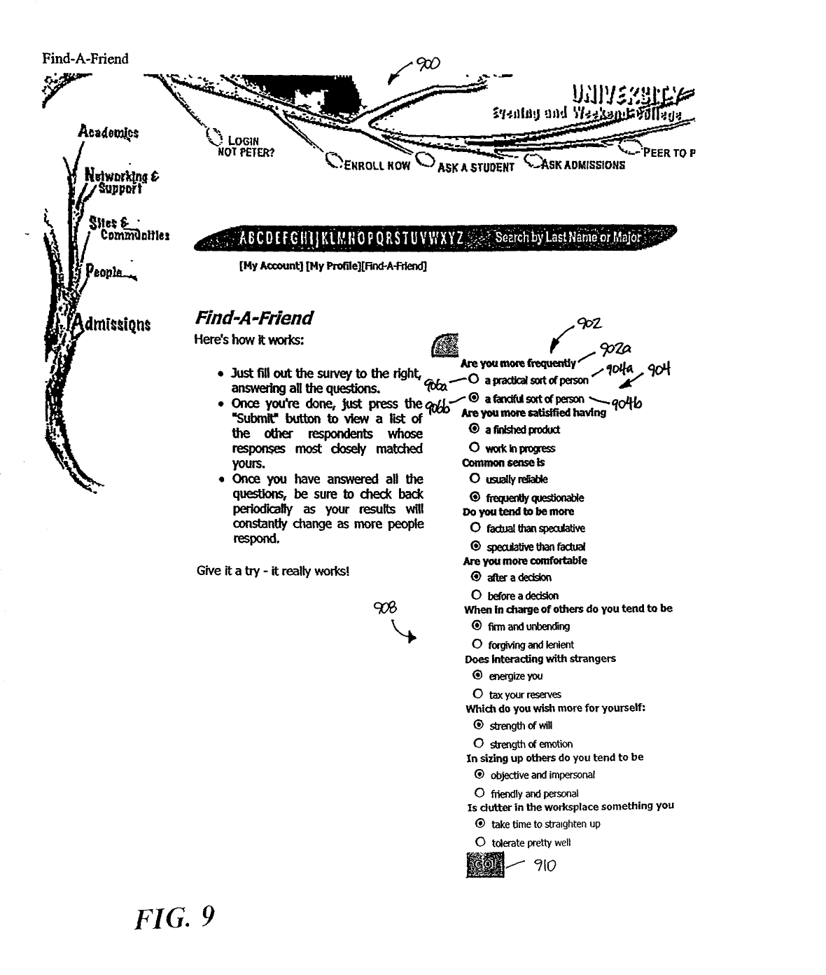

FIG. 9 illustrates another screenshot of a website used in conjunction with the invention. This particular website interface 900 relates to a match survey procedure or method executed by the invention to gather personal information directly from a prospective student, and later match a prospective student with either prospective, current, or past students sharing similar interests or demographics. For example, the website interface may be part of a “Find-A-Friend” matching procedure or method that can match a prospective student with other students having similar interests and survey responses. Typically, the type of personal information collected in a matching survey procedure or method may not be determined from another source. The personal information gathered by the website interface 900 shown can then be stored and augmented by data provided by an educational institution or other source. The website interface 900 in this example includes headings 902 such as “Are you more frequently”; and corresponding subheadings 904 as responses to each heading such as “a practical sort of person”, and “a fanciful sort of person”. Each heading 902 has one or more corresponding subheadings 904 that query or otherwise prompt a prospective student to enter information into an associated check box or radio button 906. For example, a heading such as “Are you more satisfied having” 902a can have corresponding subheadings such as “a finished product” 904a, or “work in progress” 904b. A respective radio button 906a-b immediately adjacent to each subheading 904a-b provides a prospective student with an interface to enter information responsive to each specific subheading 904a-b by way of an input device such as a keyboard or mouse. In this example, a collection routine 102 may utilize the collected information from a prospective student with a procedure that augments the information with data provided or otherwise collected by an educational institution 112a or another source, such as behavioral data of current and prior students at a particular educational institution. The type of information collected in the website interface 900 can then be used to match a prospective student with one or more prospective, current, or prior students. Alternatively, the information can be used to predict the behavior of a prospective student based upon the survey results, behavioral data and observations of current and prior students. The match and/or prediction can then be further utilized by the collection routine 102 or invention. Other headings, subheadings, and radio boxes can exist.

Additional personal or survey information 908 such as data that permits an observation to be made about the prospective student can be collected by the website interface 900. Other personal and survey information questions can be displayed, and associated input can be collected and stored by the website interface 900. When a prospective student has completed data entry for the website interface 900 and is ready to move to a subsequent webpage, he/she depresses the “GO!” button 910 by way of an input device or mouse.

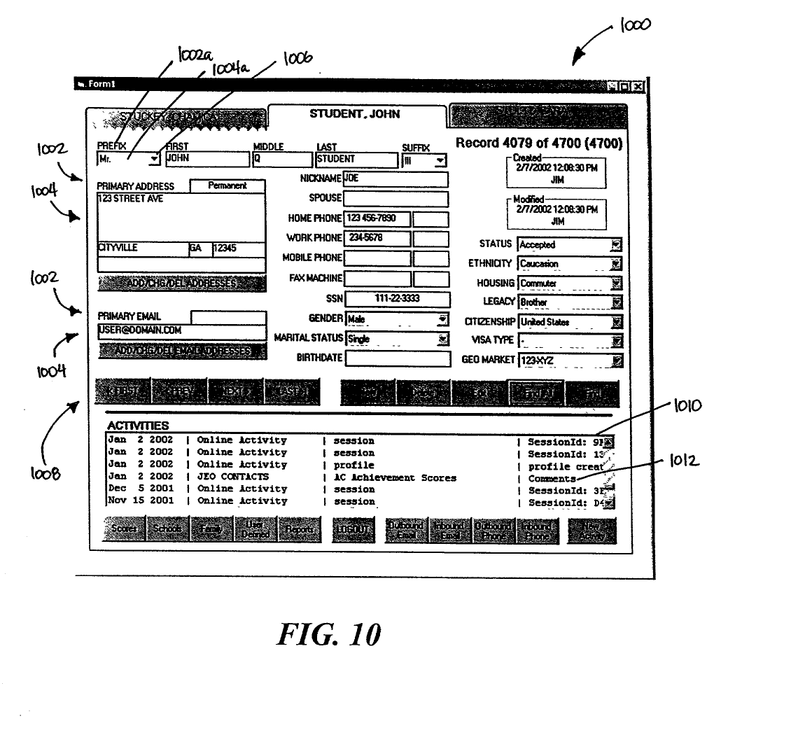

FIG. 10 illustrates another screenshot of a website used in conjunction with the invention. As described previously in FIG. 2, information can be received from a student 110a-n by the collection routine 102 via the Internet 114 or network; and then stored in the database 122 associated with the main computer 120, or in the main computer 120, until called upon by another routine 104, 106, 108 associated with the system 100. Alternatively, the educational institution 112a or admissions office 112b can provide information to the database 122 such as biographical, historical, and statistical information about students 110a-n to the database 122 associated with the main computer 120. Other sources of information may provide useful information such as historical, demographic, or circumstantial data to the database 122. An example of a website interface 1000 for viewing a form or record stored in a database 122 is shown in FIG. 10. This particular website interface 1000 relates to a contact management procedure or method executed by the invention to store and retrieve personal information associated with a prospective, current, or prior student. The personal information collected for a particular student is displayed by the website interface 1000 and augmented by data provided by an educational institution or other source. The website interface 1000 in this example includes headings 1002 such as “Primary Address”, and “Primary Email”. Each heading 1002 has one or more associated text fields 1004 that display collected information or otherwise permit entry of information by a third-party or authorized user in a text field 1004. For example, the “Prefix” heading 1002a can have a text field 1004a with collected information already entered into the field 1004a, and can further include a text pull-down box 1006 to permit entry of corrected or changed information into the text field 1004a. Other headings and associated fields can exist including, but not limited to, names, addresses, and other types of personal information.

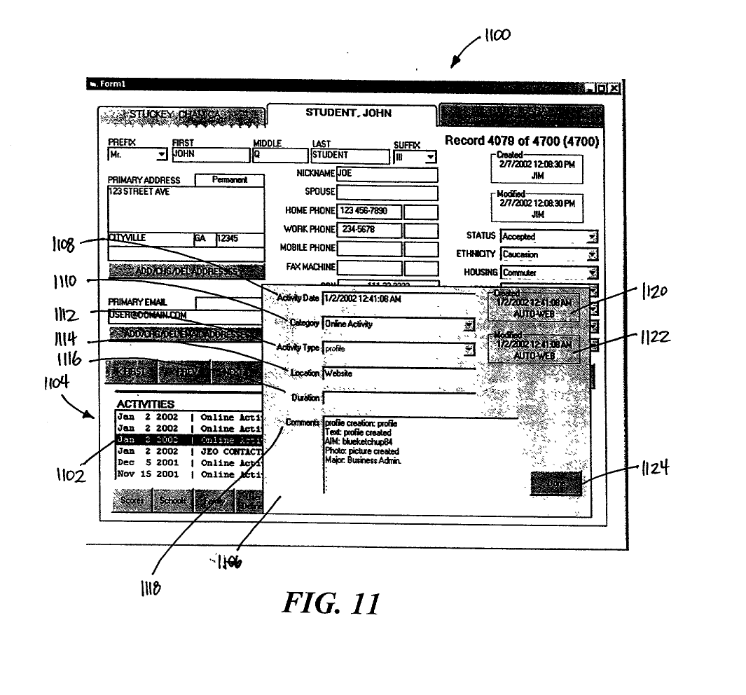

Additional editing commands and associated buttons 1008 for further categorization and viewing of individual student data are shown. Other editing commands and buttons can be provided. These additional functions can be associated with a contact management procedure or method executed by the invention to store and retrieve personal information associated with a prospective, current, or prior student. For example, an administrator may want to view a particular activity or contact with a prospective student. An “Activities” field 1010 displays one or more line item records 1012 of activities or contacts with the prospective student. By way of an input device such as a keyboard or mouse, the administrator may highlight a particular line item record to examine a particular activity or contact for additional detail, as shown in FIG. 11.

FIG. 11 illustrates another screenshot of a website used in conjunction with the invention. As described previously in FIG. 10, the invention can execute a contact management procedure or method to store and retrieve personal information associated with a prospective, current, or prior student. The personal information collected for a particular student is displayed by the website interface 1100 and augmented by data provided by an educational institution or other source. The website interface 1100 in this example is similar to that shown in FIG. 10.

When an administrator highlights a particular line item record 1102 in the “Activities” field 1104 to examine a particular activity or contact for additional detail, a pop-up box 1106 appears with additional fields containing details about a particular line item record. The details in this example include “Activity Date” 1108, “Category” 1110, “Activity Type” 1112, “Location” 1114, “Duration” 1116, Comments” 1118, “Created” 1120, and “Modified” 1122. Other details and related information may be provided as needed.

When the administrator has completed viewing or editing a particular line item and is ready to move to a subsequent line item or webpage, he/she depresses the “Done” button 1124 by way of an input device or mouse.

FIG. 12 illustrates a report generated in conjunction with the invention. As previously described in FIG. 2, a predictive routine 104 creates or generates a prediction about a prospective student 110a-n based upon collected information from the collection routine 102 and the database 122. The predictive routine 104 can create or generate a prediction about whether a particular student will enroll in an educational institution 112a. The predictive routine 104 can include a dynamic predictive model or algorithm utilizing statistical and/or quantitative analysis techniques and methods. Statistical and/or quantitative analysis techniques and methods can include, but are not limited to, conventional statistical analysis, quantitative analysis, and a proprietary or non-proprietary set of routines or algorithms. An example of a report is illustrated as a website interface 1200 displaying an individual analysis of a prospective student and for viewing a prediction generated by a predictive model is shown in FIG. 12. This particular website interface 1200 relates to a prediction reporting procedure or method executed by the invention to generate a prediction based on received, stored and/or retrieved personal information associated with a prospective, current, or prior student. In this example, a prediction 1202 about a prospective student and an associated set of predictive factors 1204 for the prediction generated are shown. The prediction 1202, shown as a “Current Projection”, illustrates a likelihood of acceptance based upon a correlation of one or more prediction factors 1204. As described previously, prediction factors 1204 can include, but are not limited to, individual or combinations of static factors and/or website usage factors. The predictive routine 104 correlates one or more prediction factors to generate a prediction about a prospective student.

Generally, the prediction factors 1204 can also be organized into groups such as “Contact Factors” 1206, “Site Usage Factors” 1208, and “Interest Weighting Factors” 1210. Other groups of prediction factors can be generated depending upon the organization of prediction factors or the decision of an educational institution 112a.

Contact Factors 1206 can include prediction factors that are indicative of specific types of contacts that have been made with a particular student. Contact Factors 1206 include, but are not limited to, telephone contacts, college fairs, and campus visits.

Site Usage Factors 1208 can include prediction factors that are indicative of specific data that shows a particular student's behavior or usage of one or more Internet websites associated with the invention. Site Usage Factors 1208 include, but are not limited to, total page views, page views per session, frequency of sessions, and duration of sessions.

Interest Weighting Factors 1210 can include prediction factors that are indicative of data that reflects a particular student's interests in curricula and/or activities. Interest Weighting Factors 1210 include, but are not limited to, action categories as defined previously in FIG. 6 such as arts & humanities, business & economy, computers & Internet, education, entertainment, government, health, news & media, recreation & sports, reference, regional & location, sciences, social sciences, and society & culture.

Each predictive factor 1204 may have a particular ranking of the likelihood of a student decision based upon past or present student data as shown by 1212. Depending upon the predictive algorithm selected or generated by an educational institution 112a or by the predictive routine 104, each of the predictive factors 1204 or groups 1206 of prediction factors can be correlated to permit a prediction such as 1202 to be generated for a prospective student.

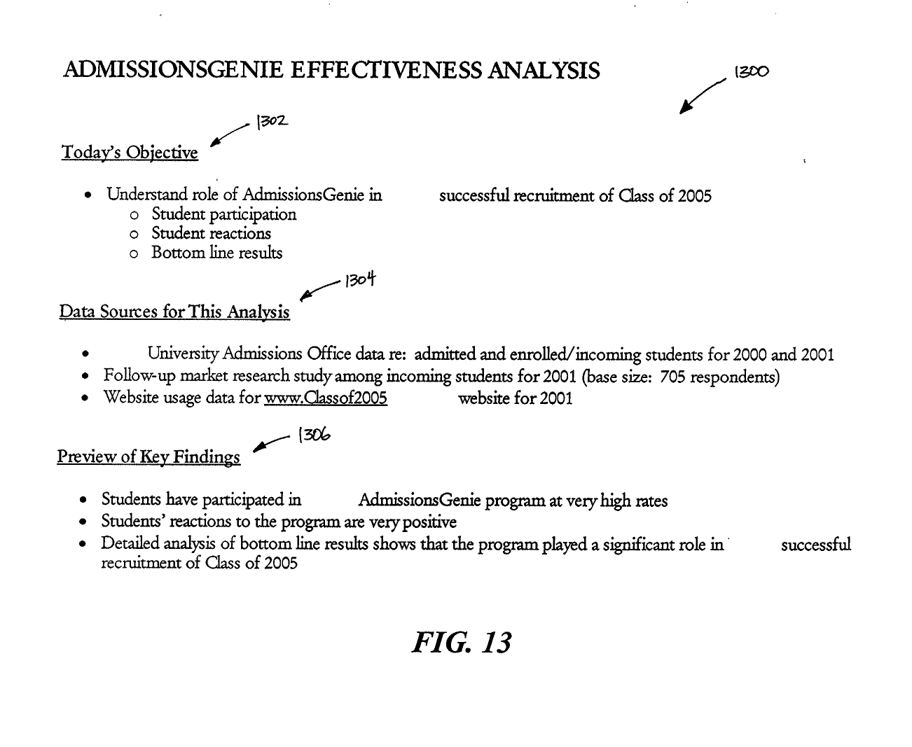

FIG. 13 illustrates another report generated in conjunction with the invention. As described previously in FIGS. 2 and 6, the predictive routine 104 converts one or more of the generated predictions to useful reports for the decision making routine 106 to handle. A useful report can include a form in an electronic or physical format that includes one or more predictions about a particular student's potential decision. The decision making routine 106 can utilize one or more predictions to initiate a decision related to a particular student. Based upon the decisions made for one or more students at an educational institution 112a, another report such as an effectiveness and yield results report 1300 in FIG. 13 can be generated by the invention.

The effectiveness report 1300 can be utilized by an educational institution 112a to view and evaluate the effectiveness and yield results attributable to one or more decisions made in accordance with or otherwise based in part upon a prediction generated by the invention. An effectiveness report 1300 can describe objectives 1302, data sources 1304, key findings 1306, and other information useful to summarize the effects of one or more decisions made in accordance with or otherwise based in part upon a prediction generated by the invention.

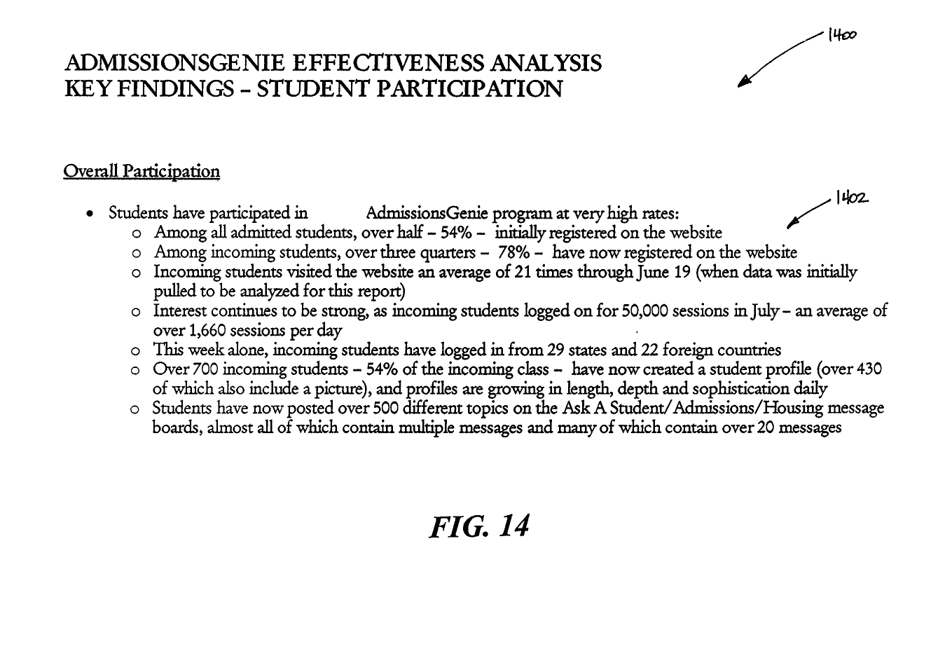

FIGS. 14-21 illustrate pages of the report as described in FIG. 13. FIG. 14 shows key finding observations 1400 associated with overall participation of prospective students with one or more methods or procedures implemented by the invention. For example, the invention can determine and report statistical information 1402 relating to initial registration of admitted students with an associated Internet website. Other statistical information can include, but is not limited to, registration of incoming students with an associated Internet website, number of visits to an associated Internet website, reported nationality of students interacting with an associated Internet website, and numbers of different messages and topics posted to an associated message board.

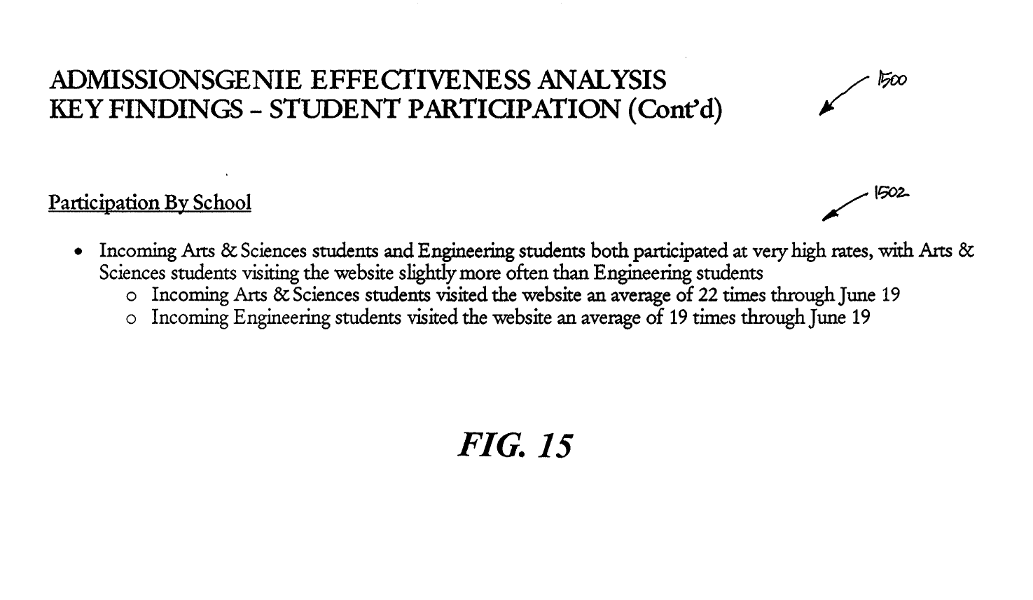

FIG. 15 shows key finding observations 1500 associated with overall participation by school or college of prospective students with one or more methods or procedures implemented by the invention. For example, the invention can determine and report statistical information 1502 relating to participation by prospective or incoming students to particular schools or colleges within an educational institution 112a, such as comparing the frequency of Internet website visits by incoming arts & science students with the frequency of Internet website visits by engineering students.

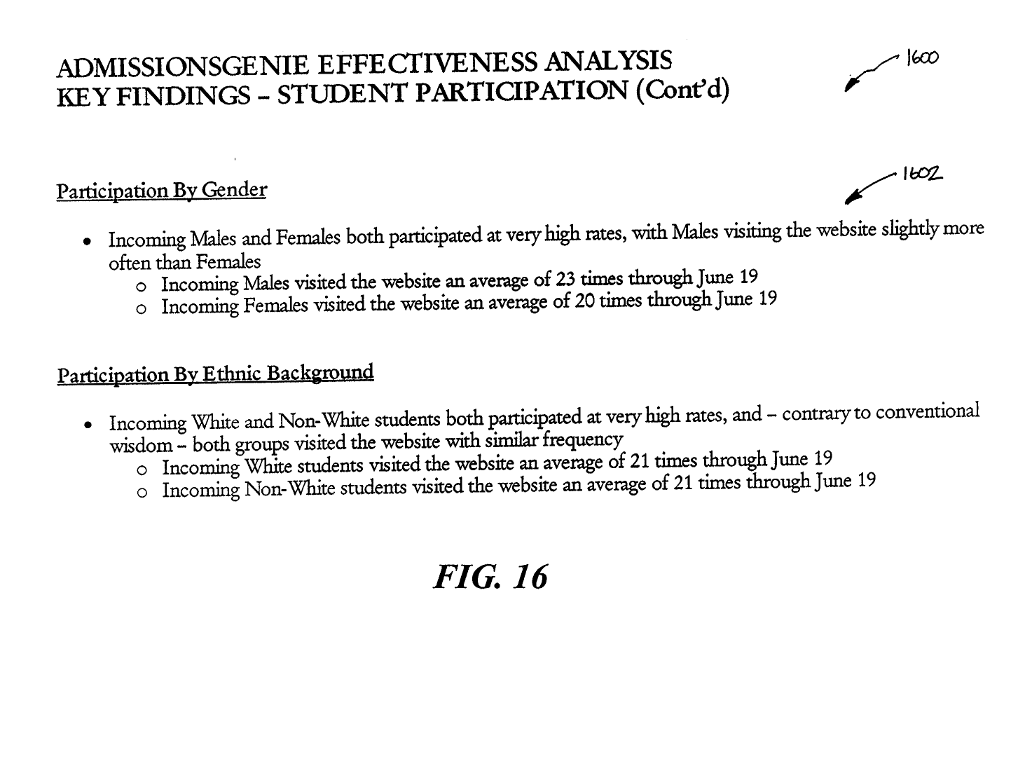

FIG. 16 shows key finding observations 1600 associated with overall participation by prospective students of a particular gender or ethnic background. For example, the invention can determine and report statistical information 1602 relating to participation by prospective or incoming students of a certain gender or ethnic background, such as the frequency of visits by males vs. females.

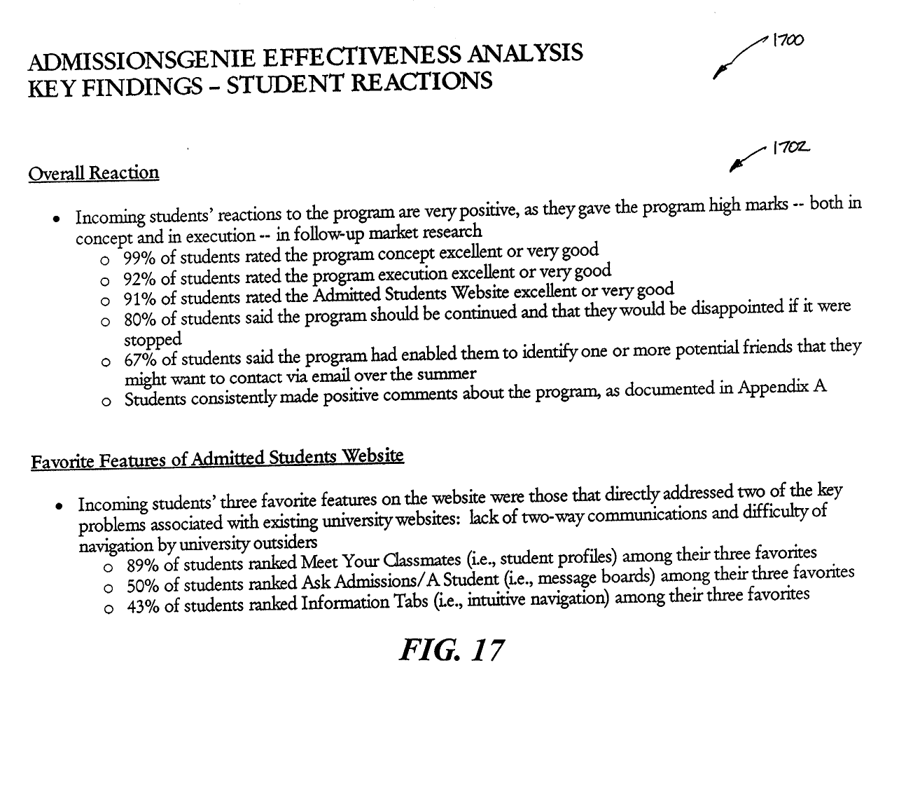

FIG. 17 shows key finding observations 1700 associated with overall reactions by prospective students. For example, the invention can determine and report statistical information 1702 relating to survey results of prospective or incoming students, such as rating relative student reaction to an associated Internet website or features on an associated Internet website.

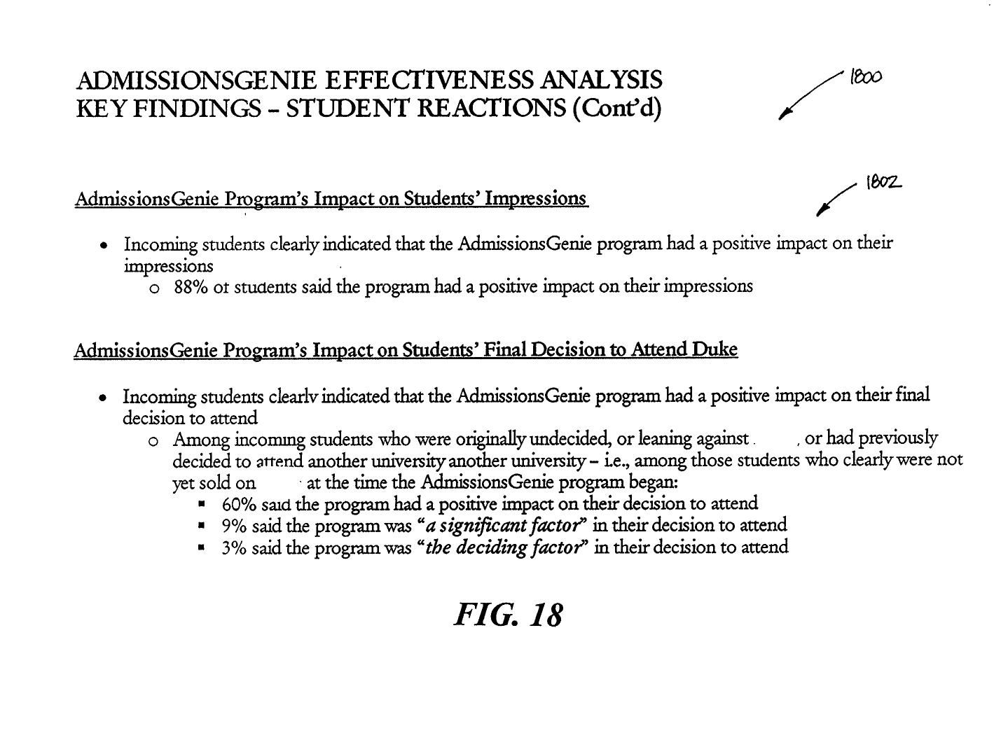

FIG. 18 shows key finding observations 1800 associated with overall reactions by prospective students. For example, the invention can determine and report statistical information 1802 relating to survey results of prospective or incoming students, such as rating the relative impact of an associated Internet website on the student impressions of an educational institution or the relative impact on an admission decision to attend the educational institution.

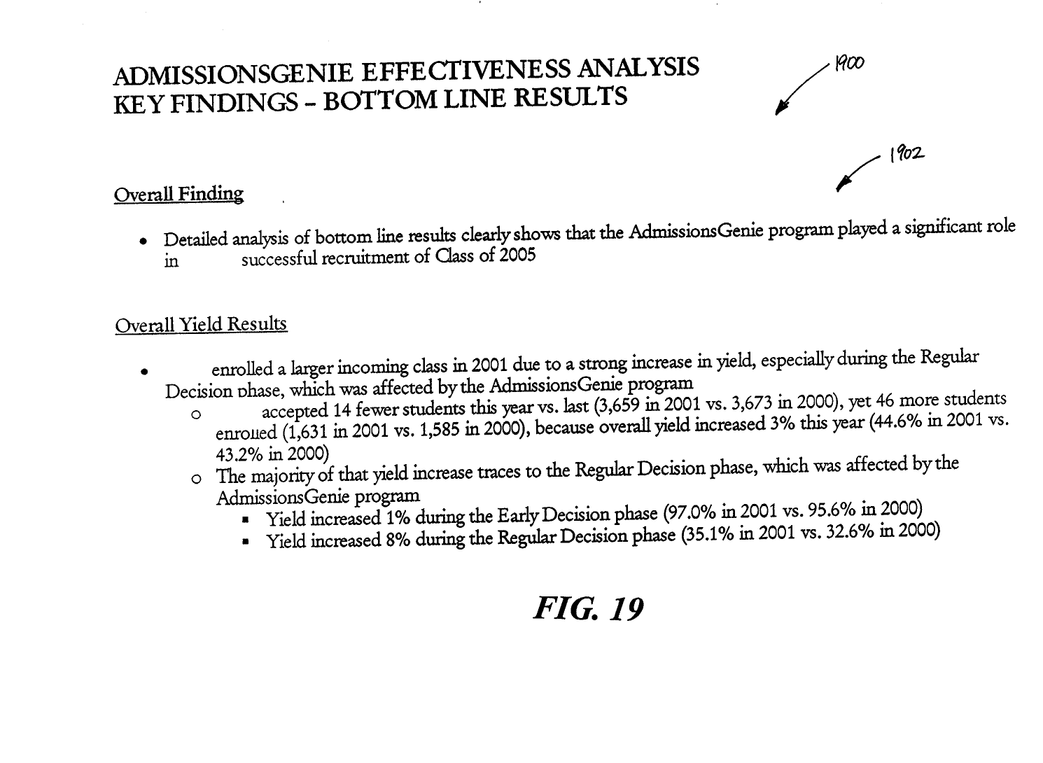

FIG. 19 shows key finding observations 1900 associated with bottom line results of the invention on an enrollment yield for an educational institution. For example, the invention can determine and report statistical information 1902 relating enrollment yield comparing a current year with past years, or comparing yields of an early decision phase with the yields of a regular decision phase.

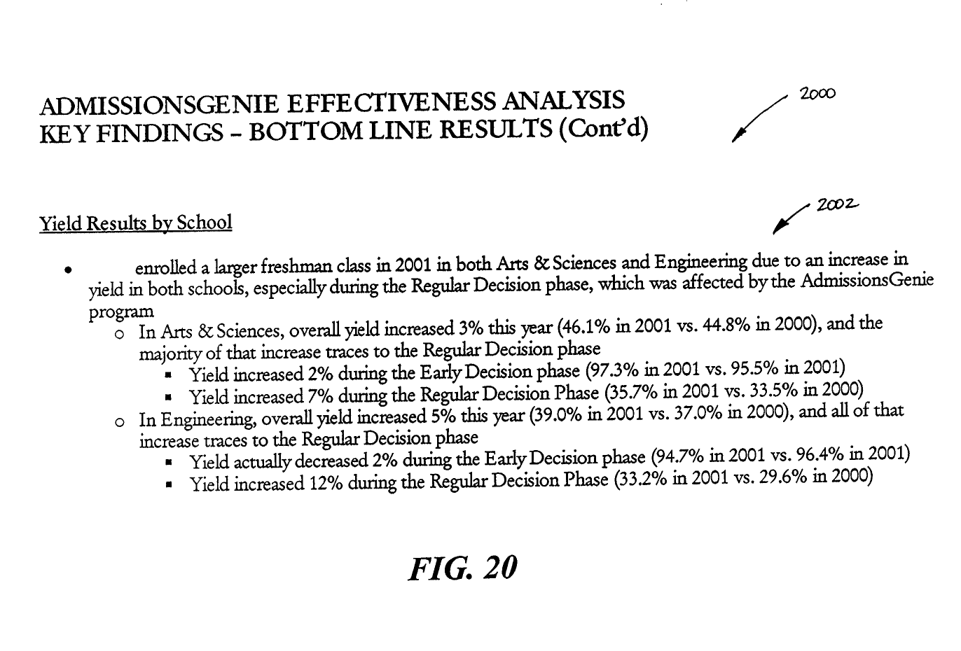

FIG. 20 shows key finding observations 2000 associated with bottom line results of the invention on an enrollment yield for an educational institution. For example, the invention can determine and report statistical information 2002 relating to yield results of prospective or incoming students by scholastic aptitude scores or other test scores.

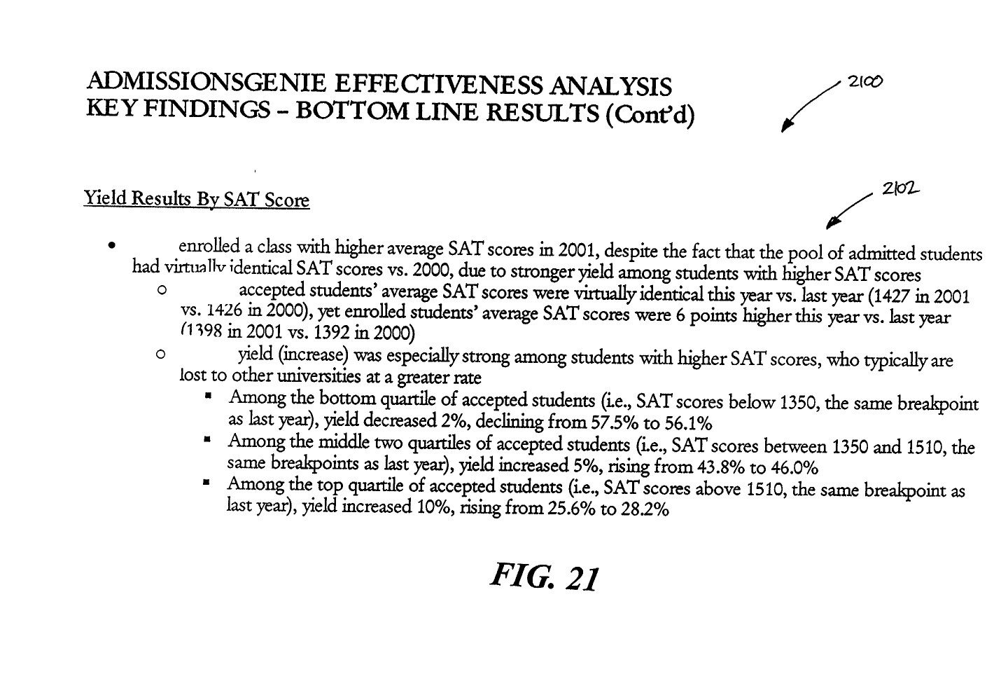

FIG. 21 shows key finding observations 2100 associated with bottom line results of the invention on an enrollment yield for an educational institution. For example, the invention can determine and report statistical information 2102 relating to yield results of prospective or incoming students by SAT® score for particular ranges, years, and student groups.

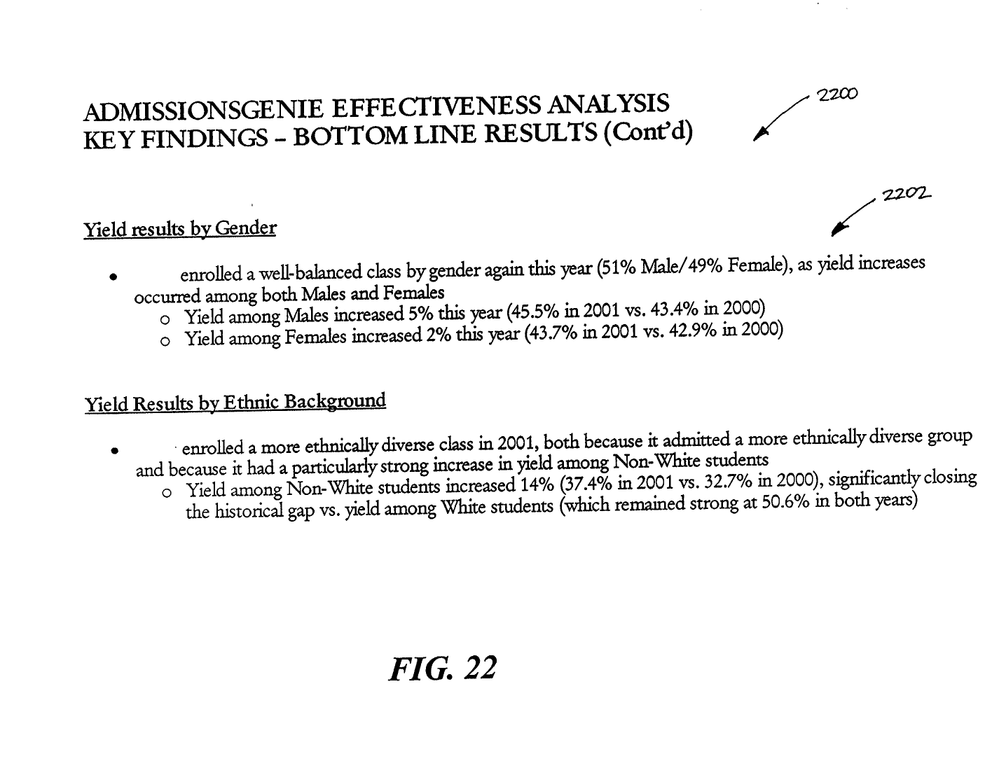

FIG. 22 shows key finding observations 2200 associated with bottom line results of the invention on an enrollment yield for an educational institution. For example, the invention can determine and report statistical information 2202 relating to yield results of prospective or incoming students by gender or ethnic background such as male vs. female.

The reports illustrated in FIGS. 12-22 are examples of the types of information that the invention can generate and provide. Other types of statistical information can be generated, provided, and conveyed by the invention in a report.

Alternative embodiments will become apparent to those skilled in the art to which the invention pertains without departing from its spirit and scope. It is expected that the invention can be used in other similar types of environments utilizing similar types of information.

The invention we claim is:

1. A method for predicting an enrollment decision of a prospective student, comprising:
receiving information associated with the prospective student via a network;
determining one or more predictive factors based upon selected prospective student information; and
determining a likelihood of an enrollment decision by the prospective student based upon at least one predictive factor.

2. The method of claim 1, wherein receiving information associated with the prospective student via a network, comprises:
receiving information consisting of at least one of the following: static data, biographical data, statistical data, historical data, behavioral data, preferential data, circumstantial data, demographic data, or other data that permits an observation to be made about the prospective student.

3. The method of claim 1, wherein determining one or more predictive factors based upon selected prospective student information, comprises:
developing a predictive algorithm that correlates one or more predictive factors based upon selected prospective student information.

4. The method of claim 3, wherein the predictive algorithm is derived in part from at least one of the following: dynamic predictive model, statistical analysis, conventional statistical analysis, quantitative analysis, linear regression, non-linear regression, multi-variable regression, cluster analysis, or neural network analysis.

5. The method of claim 1, wherein determining a likelihood of an enrollment decision based upon at least one predictive factor, comprises:
utilizing a result based upon at least one predictive factor.

6. The method of claim 1, further comprising:
storing information associated with the prospective student;
updating one or more predictive factors based upon selected prospective student information;
determining a likelihood of an enrollment decision based upon at least one updated predictive factor.

7. The method of claim 1, further comprising:
determining whether additional information from has been received about a prospective student;
updating information associated with the prospective student; and
updating one or more predictive factors based upon additional information received about a prospective student.

8. The method of claim 1, wherein a predictive factor consists of one of the following: contact usage factor, site usage factor, and interest weighting factor.

9. The method of claim 1, wherein an enrollment decision comprises whether to attend a particular educational institution.

10. The method of claim 3, wherein developing a predictive algorithm that correlates one or more predictive factors based upon selected prospective student information, further comprises:
receiving additional information associated with a prospective student;
sorting relevant information into one or more prediction cells;
determining a predictive factor for each prediction cell; and
correlating one or more predictive factors to make a prediction about a student decision based upon the relevant information.

11. A system for generating a prediction for an enrollment decision about a prospective student, comprising:
a set of computer-executable instructions configured to
receive information associated with a prospective student;
determine one or more predictive factors based upon selected prospective student information; and
determine a likelihood of an enrollment decision by the prospective student based upon at least one predictive factor.

12. The system of claim 11, wherein information associated with a prospective student consists of at least one of the following: static data, biographical data, statistical data, historical data, behavioral data, preferential data, circumstantial data, demographic data, or other data that permits an observation to be made about the prospective student.

13. The system of claim 12, wherein the set of computer-executable instructions are further configured to,
develop a predictive algorithm that correlates one or more predictive factors based upon selected prospective student information.

14. The system of claim 13, wherein the predictive algorithm is derived in part from at least one of the following: dynamic predictive modeling, statistical analysis, conventional statistical analysis, quantitative analysis, linear regression, non-linear regression, multi-variable regression, cluster analysis, neural network analysis.

15. The system of claim 11, wherein the set of computer-executable instructions is further configured to:
utilize a result based upon at least one predictive factor.

16. The system of claim 11, wherein the set of computer-executable instructions is further configured to:
store information associated with the prospective student;
update one or more predictive factors based upon selected prospective student information; and
determine a likelihood of an enrollment decision based upon at least one updated predictive factor.

17. The system of claim 11, wherein the set of computer-executable instructions is further configured to:
determine whether additional information from has been received about a prospective student;
update information associated with the prospective student; and
update one or more predictive factors based upon additional information received about a prospective student.

18. The system of claim 11, wherein a predictive factor consists of one of the following: contact usage factor, site usage factor, and interest weighting factor.

19. The system of claim 11, wherein an enrollment decision comprises: whether to attend a particular educational institution.

20. The system of claim 12, wherein to develop a predictive algorithm that correlates one or more predictive factors based upon selected prospective student information, further comprises:
receiving additional information associated with a prospective student;
sorting relevant information into one or more prediction cells;
determining a predictive factor for each prediction cell; and
correlating one or more predictive factors to make a prediction about a student decision based upon relevant information.

21. A method for generating a prediction for enrollment of a prospective student, the method comprising:
collecting student data via a network;
collecting student data in a database;
based upon collected student data,
determining at least one predictive factor of enrollment; and
generating a probability of enrollment for a prospective student from student data.

22. The method of claim 21, wherein collecting student data via a network comprises collecting at least one of the following types of information: static data, biographical data, statistical data, historical data, behavioral data, preferential data, circumstantial data, demographic data, or other data that permits an observation to be made about the prospective student.

23. The method of claim 21, wherein collecting student data in a database comprises collecting at least one of the following types of information: static data, biographical data, statistical data, historical data, behavioral data, preferential data, circumstantial data, demographic data, or other data that permits an observation to be made about the prospective student.

24. The method of claim 21, wherein determining at least one predictive factor of enrollment comprises:
determining from the collected student data which data may be relevant to an enrollment decision;
assigning a predictive value to the relevant data;
comparing a prospective student's data to relevant data; and
accumulating the predictive values for a prospective student's data.

25. The method of claim 21, further comprising:
communicating with the prospective student based upon the probability of enrollment;
receiving feedback from the prospective student;
updating one or more predictive factors based upon the feedback;
generating a new probability of enrollment for the prospective student.

26. A method of generating a model for making a prediction about a prospective student, comprising:
receiving information associated with a prospective student; and
determining a set of predictive factors based on a selected portion of the prospective student information, wherein a correlation of at least one predictive factor can be made to determine a potential decision of a prospective student.

27. The method of claim 26, wherein receiving information associated with a prospective student, comprises:
selecting data unlikely to be affected by input data; and
sorting remaining data into one or more prediction cells.

28. The method of claim 26, further comprising:
storing prospective student information in a database;
receiving updated information associated with the prospective student;
updating prospective student information in the database; and
determining a new set of predictive factors based on a selected portion of the updated prospective student information, wherein each new predictive factor is a correlation of a potential decision of a prospective student.

29. The method of claim 26, further comprising:
storing prospective student information in a database;
receiving decision information associated with the prospective student;
updating prospective student information in the database; and
determining a new set of predictive factors based on a selected portion of the updated prospective student information, wherein each new predictive factor is a correlation of a potential decision of a prospective student.

30. A method for improving prospective student yields at an educational institution, wherein each prospective student transmits an application to the educational institution, the method comprising:
receiving information associated with a prospective student;
determining one or more predictive factors based upon selected prospective student information;
determining a likelihood of an enrollment decision based upon at least one predictive factor; and
making a decision to interact with the prospective student based upon a particular likelihood of an enrollment decision.

31. A method for predicting a decision of a person, comprising:
receiving information associated with the person via a network;
determining one or more predictive factors based upon selected personal information; and
determining a likelihood of a decision by the person based upon at least one predictive factor.

32. The method of claim 31, wherein receiving information associated with the person via a network, comprises:
receiving information consisting of at least one of the following: static data, biographical data, statistical data, historical data, behavioral data, preferential data, circumstantial data, demographic data, or other data that permits an observation to be made about the person.

33. The method of claim 31, wherein determining one or more predictive factors based upon selected personal information, comprises:
developing a predictive algorithm that correlates one or more predictive factors based upon selected personal information.

34. The method of claim 33, wherein the predictive algorithm is derived in part from at least one of the following: dynamic predictive model, statistical analysis, conventional statistical analysis, quantitative analysis, linear regression, non-linear regression, multi-variable regression, cluster analysis, or neural network analysis.

35. The method of claim 31, wherein determining a likelihood of a decision based upon at least one predictive factor, comprises:
utilizing a result based upon at least one predictive factor.

36. The method of claim 31, further comprising:
storing information associated with the person;
updating one or more predictive factors based upon selected personal information;
determining a likelihood of an enrollment decision based upon at least one updated predictive factor.

37. The method of claim 31, further comprising:
determining whether additional information from has been received about a person;
updating information associated with the person; and
updating one or more predictive factors based upon additional information received about a person.

38. The method of claim 31, wherein a predictive factor consists of one of the following: contact usage factor, site usage factor, and interest weighting factor.

39. The method of claim 33, wherein developing a predictive algorithm that correlates one or more predictive factors based upon selected personal information, further comprises:
receiving additional information associated with a person;
sorting relevant information into one or more prediction cells;
determining a predictive factor for each prediction cell; and
correlating one or more predictive factors to make a prediction about a decision based upon the relevant information.

40. A system for generating a prediction for a decision about a person, comprising:
a set of computer-executable instructions configured to
receive information associated with a person;
determine one or more predictive factors based upon selected personal information; and
determine a likelihood of a decision by the person based upon at least one predictive factor.
